(19) United States
(12) Patent Application Publication
(10) Pub. No.: US 2025/0234339 A1
(43) Pub. Date: Jul. 17, 2025

(54) METHOD AND APPARATUS FOR OBTAINING CHANNEL INFORMATION FOR IMPROVING LINK ADAPTATION IN WIRELESS COMMUNICATION SYSTEM

(71) Applicant: SAMSUNG ELECTRONICS CO., LTD., Suwon-si (KR)

(72) Inventors: Hyunsik YOON, Suwon-si (KR); Sundo KIM, Suwon-si (KR); Seunghyun LEE, Suwon-si (KR)

(21) Appl. No.: 19/029,410

(22) Filed: Jan. 17, 2025

(30) Foreign Application Priority Data
Jan. 17, 2024 (KR) 10-2024-0007342
Jan. 15, 2025 (KR) 10-2025-0006099

(51) Int. Cl. H04W 72/0446; H04W 72/232

(52) U.S. Cl. CPC H04W 72/0446; H04W 72/232

(57) ABSTRACT

The disclosure relates to a 5G or 6G communication system for supporting a higher data transfer rate than a 4G communication system such as LTE. A method of a terminal in a wireless communication system includes receiving, from a base station, a reference signal to be used for measuring channel information for each of at least one slot, including a demodulation reference signal (DMRS) related to reception of a physical downlink shared channel (PDSCH), measuring channel information including an interference amount for each of the at least one slot, based on the reference signal, obtaining slot-related channel information, based on the measured channel information for each of the at least one slot, and transmitting the obtained slot-related channel information to the base station. In the method the slot-related channel information is used to determine a modulation and coding scheme (MCS) level for each of at least one slot group.

### CROSS-REFERENCE TO RELATED APPLICATIONS

This application is based on and claims priority under 35 U.S.C. § 119 to Korean Patent Application No. 10-2024-0007342, filed on Jan. 17, 2024, and Korean Patent Application No. 10-2025-0006099, filed on Jan. 15, 2025, in the Korean Intellectual Property Office, the disclosures of which are herein incorporated by reference in their entireties.

### BACKGROUND

### 1. Field

The disclosure relates to a wireless communication system. Specifically, the disclosure relates to a method and apparatus for obtaining channel information for improving link adaptation.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As described above and with the development of wireless communication systems, various services can be provided, and thus, schemes to smoothly provide such services may be required. Specifically, in the wireless communication systems, for the purpose of improving link adaptation methods for smooth data transfer, technologies related to obtaining and transmitting channel information for each slot may be required.

### SUMMARY

The disclosure is intended to improve a link adaptation method by obtaining channel information per slot in a wireless communication system and generating slot group information for determining a modulation and coding scheme (MCS) level per slot group based thereon.

The disclosure proposes a method for obtaining channel information per slot to improve a link adaptation method in a wireless communication system, and a related apparatus.

According to an embodiment of the disclosure, a method of a terminal in a wireless communication system is provided. This method includes receiving, from a base station, a reference signal to be used for measuring channel information for each of at least one slot, including a demodulation reference signal (DMRS) related to reception of a physical downlink shared channel (PDSCH); measuring channel information including an interference amount for each of the at least one slot, based on the reference signal; obtaining slot-related channel information, based on the measured channel information for each of the at least one slot; and transmitting the obtained slot-related channel information to the base station. In this method, the slot-related channel information is used to determine a modulation and coding scheme (MCS) level for each of at least one slot group.

According to another embodiment of the disclosure, a method of a base station in a wireless communication system is provided. This method includes transmitting, to a terminal, a reference signal to be used for measuring channel information for each of at least one slot, including a demodulation reference signal (DMRS) related to reception of a physical downlink shared channel (PDSCH); and receiving slot-related channel information from the terminal. In this method, the slot-related channel information is used to determine a modulation and coding scheme (MCS) level for each of at least one slot group, the slot-related channel information is information obtained by the terminal, based on channel information for each of the at least one slot measured by the terminal, and the slot-related channel information is information received from the terminal.

According to still another embodiment of the disclosure, a terminal in a wireless communication system is provided. The terminal includes a transceiver and a processor operatively connected to the transceiver. The processor is configured to receive, from a base station, a reference signal to be used for measuring channel information for each of at least one slot, including a demodulation reference signal (DMRS) related to reception of a physical downlink shared channel (PDSCH), to measure channel information including an interference amount for each of the at least one slot, based on the reference signal, to obtain slot-related channel information, based on the measured channel information for each of the at least one slot, and to transmit the obtained slot-related channel information to the base station. In the terminal, the slot-related channel information is used to determine a modulation and coding scheme (MCS) level for each of at least one slot group.

According to yet another embodiment of the disclosure, a base station in a wireless communication system is provided. The base station includes a transceiver and a processor operatively connected to the transceiver. The processor is configured to transmit, to a terminal, a reference signal to be used for measuring channel information for each of at least one slot, including a demodulation reference signal (DMRS) related to reception of a physical downlink shared channel (PDSCH), and to receive slot-related channel information from the terminal. In the base station, the slot-related channel information is used to determine a modulation and coding scheme (MCS) level for each of at least one slot group, the slot-related channel information is information obtained by the terminal, based on channel information for each of the at least one slot measured by the terminal, and the slot-related channel information is information received from the terminal.

The disclosure can help improve a link adaptation method based on the channel information per slot in a wireless communication system.

The effects obtainable from the disclosure are not limited to the above-mentioned effects, and other effects that are not mentioned can be clearly understood from the description below by those skilled in the art to which the disclosure belongs.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram of an example of a radio resource area in a wireless communication system according to an embodiment of the present disclosure.

FIG. 2 illustrates a diagram of an estimation of a channel state between a base station and a UE by the base station in a wireless communication system according to an embodiment of the present disclosure.

FIG. 3 illustrates a diagram of a transmission of data in relation to link adaptation in a wireless communication system according to an embodiment of the present disclosure.

FIG. 4 illustrates a diagram of an OLRC-related SINR correction process in a wireless communication system according to an embodiment of the present disclosure.

FIG. 5 illustrates a diagram of an example of radio resource allocation in the case of configuring an aggregated slot in a wireless communication system according to an embodiment of the present disclosure.

FIG. 6 illustrates a diagram of an example of radio resource allocation, divided by whether TDIA is applied, in the case of configuring an aggregated slot in a wireless communication system according to an embodiment of the present disclosure.

FIG. 7 illustrates a diagram of an average channel state per slot and an optimal MCS per slot in a time division duplexing (TDD) 4:1 wireless communication system according to an embodiment of the present disclosure.

FIG. 8 illustrates a diagram of an actual channel state per slot and a channel state predicted by a base station in a wireless communication system according to an embodiment of the present disclosure.

FIG. 9 illustrates a diagram of a process of performing group-based OLRC in a wireless communication system according to an embodiment of the present disclosure.

FIG. 10 illustrates a diagram of a method for a base station to group slots in the case where there is no report from a UE regarding channel information per slot in a wireless communication system according to an embodiment of the present disclosure.

FIG. 11 illustrates a diagram of a method for a base station to group slots based on a report from a UE regarding channel information per slot in a wireless communication system according to an embodiment of the present disclosure.

FIG. 12 illustrates a diagram of a method for obtaining interference amount related information in a wireless communication system according to an embodiment of the present disclosure.

FIG. 13 illustrates a diagram of a method for a UE to report channel information per slot to a base station without a report request from the base station in a wireless communication system according to an embodiment of the present disclosure.

FIG. 14 illustrates a diagram of a method for a UE to report channel information per slot to a base station periodically or aperiodically without a report request from the base station in a wireless communication system according to an embodiment of the present disclosure.

FIG. 15 illustrates a diagram of a method for a UE to transmit requested information to a base station based on a report request from the base station in a wireless communication system according to an embodiment of the present disclosure.

FIG. 16 illustrates a diagram of a method for a UE to report requested information to a base station periodically or aperiodically based on a report request from the base station in a wireless communication system according to an embodiment of the present disclosure.

FIG. 17 illustrates a flowchart of operations in which a UE obtains channel information per slot and transmits it to a base station in a wireless communication system according to an embodiment of the present disclosure.

FIG. 18 illustrates a flowchart of a UE's operations related to acquisition and transmission/reception of channel information per slot in a wireless communication system according to an embodiment of the present disclosure.

FIG. 19 illustrates a flowchart of a base station's operations related to acquisition and transmission/reception of channel information per slot in a wireless communication system according to an embodiment of the present disclosure.

FIG. 20 illustrates a diagram of slot groups generated according to an embodiment of the present disclosure.

FIG. 21 illustrates a diagram of a slot group generated according to an embodiment of the present disclosure.

FIG. 22 illustrates a diagram of slot groups generated in multiple layers according to an embodiment of the present disclosure.

FIG. 23 illustrates a diagram of an average channel state per slot and an optimal MCS per slot when a base station configures a Heavy BO slot group in a wireless communication system according to an embodiment of the present disclosure.

FIG. 24 illustrates a diagram of slot groups generated in multiple layers according to an embodiment of the present disclosure.

FIG. 25 illustrates a diagram of an average channel state per slot and an optimal MCS per slot when a base station configures a Heavy BO slot group and an aggregated slot based on TDIA in a wireless communication system according to an embodiment of the present disclosure.

FIG. 26 illustrates a diagram of slot groups generated in multiple layers according to an embodiment of the present disclosure.

FIG. 27A illustrates a diagram of graphs comparing the times for the base station to adapt to the channel state for the case where slot groups are formed in a single layer and the case where slot groups are formed in two layers according to an embodiment of the present disclosure.

FIG. 27B illustrates a diagram of graphs comparing the times for the base station to adapt to the channel state for the case where slot groups are formed in a single layer and the case where slot groups are formed in three layers according to an embodiment of the present disclosure.

FIG. 28 illustrates a block diagram of a UE in a wireless communication system according to an embodiment of the present disclosure.

FIG. 29 illustrates a block diagram of a base station in a wireless communication system according to an embodiment of the present disclosure.

### DETAILED DESCRIPTION

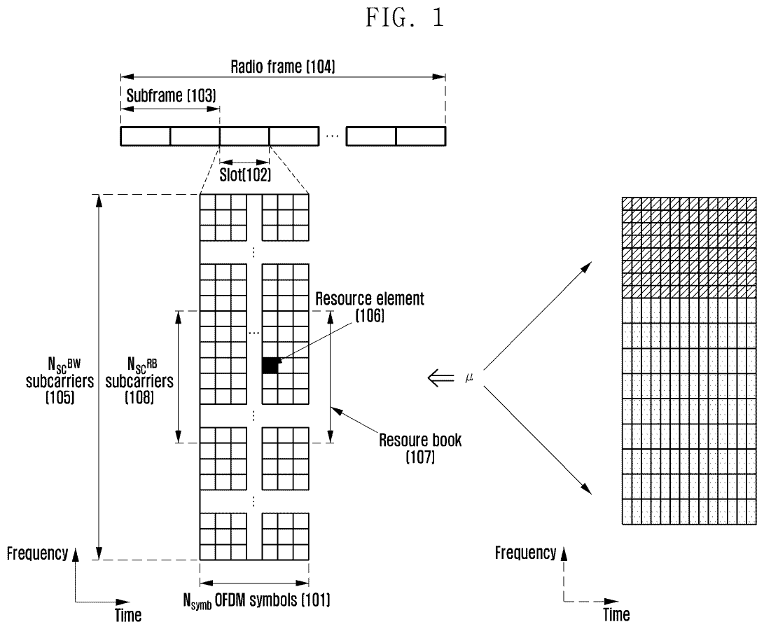

FIGS. 1 through 29, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Now, various embodiments of the disclosure will be described in detail with reference to the accompanying drawings.

In the following description of embodiments, descriptions of techniques that are well known in the art and not directly related to the disclosure are omitted. This is to clearly convey the subject matter of the disclosure by omitting any unnecessary explanation.

For the same reason, some elements in the drawings are exaggerated, omitted, or schematically illustrated. Also, the size of each element does not entirely reflect the actual size. In the drawings, the same or corresponding elements are denoted by the same reference numerals.

The advantages and features of the disclosure and the manner of achieving them will become apparent with reference to embodiments described in detail below and with reference to the accompanying drawings. The disclosure may, however, be embodied in many different forms and should not be construed as being limited to the embodiments set forth herein. Rather, these embodiments are provided so that the disclosure will be thorough and complete and will fully convey the scope of the disclosure to those skilled in the art. The disclosure is may only be defined by the scope of claims. In the disclosure, the same reference numerals are used to indicate the same elements. In addition, if it is determined that a detailed description of a related function or configuration unnecessarily obscures the subject matter of the disclosure, the detailed description will be omitted. Further, the terms used herein are terms defined in consideration of functions in the disclosure, and may vary according to a user's or operator's intention or customs. Therefore, the definition should be made based on the content throughout the disclosure.

In the disclosure, a base station refers to an entity performing resource allocation of a terminal, and may be at least one of a gNode B (gNB), an eNode B (CNB), a Node B, a base station (BS), a radio access unit, a base station controller, or a node on a network. Also, a terminal may include a user equipment (UE), a mobile station (MS), a cellular phone, a smart phone, a computer, or a multimedia system capable of performing a communication function. In the disclosure, a downlink (DL) refers to a wireless transmission path of a signal transmitted from a base station to a terminal, and an uplink (UL) refers to a wireless transmission path of a signal transmitted from a terminal to a base station. Although embodiments of the disclosure will be described below using an NR system as an example, such embodiments may also be applied to other communication systems having a similar technical background or channel type. In addition, the embodiments of the disclosure may be applied to other communication systems through some modifications within a range that does not significantly depart from the scope of the disclosure as will be apparent to a person skilled in the art.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block or blocks. These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In addition, singular expressions such as “a/an” and “the” may include plural expressions unless the context clearly dictates otherwise. Also, expressions including ordinal numbers such as “first” and “second” may indicate various elements. The above expressions do not limit the sequence or importance of the elements, and are used merely for the purpose to distinguish one element from the others. For example, without departing from the scope of the disclosure, a first element may be referred to as a second element, and similarly a second element may be also referred to as a first element. The term “and/or” includes a combination of a plurality of specified items or any of a plurality of specified items.

In addition, terms used herein may be merely to describe a certain embodiment, and may not be intended to limit the disclosure. The singular expressions may include plural expressions unless the context clearly dictates otherwise. In the disclosure, the terms such as “comprise”, “include”, and “have” denote the presence of stated elements, components, operations, functions, features, and the like, but do not exclude the presence of or a possibility of addition of one or more other elements, components, operations, functions, features, and the like. Also, the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like

In the disclosure, a pilot signal may be used interchangeably with a reference signal (RS) or a pilot. Also, a transmitter may be used interchangeably with Tx or a transmitting end, and a receiver may be used interchangeably with Rx or a receiving end.

The term “unit”, as used herein, refers to a software or hardware component or device, such as a field programmable gate array (FPGA) or application specific integrated circuit (ASIC), which performs certain tasks. A unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and modules. In addition, the components and units may be implemented to operate one or more central processing units (CPUs) in a device or a secure multimedia card. Also, in embodiments, the unit may include one or more processors.

Hereinafter, various embodiments of the disclosure will be described by using a system based on LTE, LTE-A, NR, or 6G as an example, but such embodiments may also be applied to other communication systems having similar technical backgrounds or channel types. In addition, various embodiments of the disclosure may be applied to other communication systems through some modifications without significantly departing from the scope thereof as will be apparent to a person skilled in the art.

Meanwhile, in the case where two base stations are placed adjacently and their coverage overlaps in part, a strong downlink (DL) signal from one base station may cause interference to a terminal served by the other base station. In other words, inter-cell interference (ICI) may occur between a serving cell formed by one base station and an interference cell adjacent to the serving cell and causing interference.

Unlike the LTE system, the NR system is designed based on the Ultra-Lean principle to minimize the always-on transmission, so interference may not occur to adjacent cells if there is no data to be transmitted actually. Therefore, ICI control in the 5G NR system is attracting attention as one of the representative technologies for improving network performance.

In the disclosure, grouping has the same meaning as configuring a group and they can be used interchangeably. In addition, channel information per slot has the same meaning as slot-related channel information and they can be used interchangeably.

FIG. 1 illustrates a diagram of an example of a radio resource area in a wireless communication system according to an embodiment of the present disclosure.

In various embodiments, the radio resource area may include a structure in the time-frequency domain. According to an embodiment, the wireless communication system may include an NR communication system.

With reference to FIG. 1, in the radio resource area, the horizontal axis represents the time domain, and the vertical axis represents the frequency domain. The length of a radio frame 104 is 10 ms. The radio frame 104 is a time domain section composed of 10 subframes. The length of a subframe 203 is 1 ms. A unit in the time domain may be an orthogonal frequency division multiplexing (OFDM) and/or discrete Fourier transform-spread-OFDM (DFT-s-OFDM) symbol, and one slot 102 may be composed of N_{symb} OFDM and/or DFT-s-OFDM symbols 101. In various embodiments, the OFDM symbol may include a symbol for the case where a signal is transmitted and received using the OFDM multiplexing scheme, and the DFT-s-OFDM symbol may include a symbol for the case where a signal is transmitted and received using the DFT-s-OFDM or single carrier frequency division multiple access (SC-FDMA) multiplexing scheme. The minimum transmission unit in the frequency domain is a subcarrier, and a carrier bandwidth constituting a resource grid may be composed of a total of N_{sc}^{BW} subcarriers 105. In the disclosure, an embodiment regarding downlink signal transmission and reception is described for convenience of explanation, but this can also be applied to an embodiment regarding uplink signal transmission and reception.

In some embodiments, the number of slots 102 constituting one subframe 103 and the length of the slot 102 may vary depending on the subcarrier spacing. This subcarrier spacing may be referred to as a numerology (μ). That is, the subcarrier spacing, the number of slots included in the subframe, the length of the slot, and the length of the subframe may be variably configured. For example, in the NR communication system, when the subcarrier spacing (SCS) is 15 kHz, one slot 102 forms one subframe 103, and the length of each of the slot 102 and the subframe 103 may be 1 ms. In addition, for example, when the subcarrier spacing is 30 kHz, two slots may form one subframe 103. In this case, the length of the slot is 0.5 ms and the length of the subframe is 1 ms.

In some embodiments, depending on the communication system, the subcarrier spacing, the number of slots included in the subframe, the length of the slot, and the length of the subframe may be variably applied. For example, in the case of the LTE system, the subcarrier spacing may be 15 kHz, and two slots may form one subframe. In this case, the length of the slot may be 0.5 ms, and the length of the subframe may be 1 ms. In the case of the NR system, the subcarrier spacing (μ) may be one of 15 kHz, 30 kHz, 60 kHz, 120 kHz, and 240 kHz, and the number of slots included in one subframe may be 1, 2, 4, 8, or 16 depending on the subcarrier spacing (μ).

A basic unit of resources in the time-frequency domain may be a resource element (RE) 106, and the resource element 106 may be expressed by an OFDM symbol index and a subcarrier index. A resource block (RB) may include a plurality of resource elements. In the NR system, the resource block (or a physical resource block (PRB)) 107 may be defined by N_{sc}^{RB} consecutive subcarriers in the frequency domain. The number of subcarriers, N_{sc}^{RB}, may be 12. The frequency domain may include common resource blocks (CRBs). The physical resource block (PRB) may be defined in a bandwidth part (BWP) on the frequency domain. The CRB and PRB numbers may be determined differently according to the subcarrier spacing. In the LTE system, the RB may be defined by N_{symb} consecutive OFDM symbols in the time domain and N_{sc}^{RB} consecutive subcarriers in the frequency domain.

In the NR and/or LTE systems, scheduling information for downlink data or uplink data may be transmitted from a base station to a UE via downlink control information (DCI). In various embodiments, the DCI may be defined according to various formats, and each format may indicate whether the DCI includes scheduling information for uplink data (e.g., UL grant) or includes scheduling information for downlink data (DL resource allocation), whether it is compact DCI having a small size of control information, whether it is fallback DCI, whether spatial multiplexing using multiple antennas is applied, and/or whether it is DCI for power control. For example, NR DCI format 1_0 or NR DCI format 1_1 may include scheduling for downlink data. Also, for example, NR DCI format 0_0 or NR DCI format 0_1 may include scheduling for uplink data.

As described above, FIG. 1 shows an example of a downlink and uplink slot structure in the wireless communication system. In particular, FIG. 1 shows the structure of a resource grid in the 3GPP NR system. With reference to FIG. 1, the slot may include a plurality of OFDM symbols in the time domain and a plurality of resource blocks (RBs) in the frequency domain. A signal may be composed of part or all of the resource grid. In addition, the number of OFDM symbols included in one slot may vary in general depending on the length of a cyclic prefix (CP). In FIG. 1, for the convenience of explanation, the case where one slot is composed of 14 OFDM symbols is illustrated, but the signal referred to in the disclosure does not specify the configuration of symbols. In addition, a modulation scheme of the signal is not limited to quadrature amplitude modulation (QAM) of a specific value, and may follow the modulation schemes of various communication standards, such as binary phase shift keying (BPSK) and quadrature phase shift keying (QPSK).

Although various embodiments of the disclosure are described based on the LTE communication system or the NR communication system, the contents of the disclosure are not limited thereto and may be applied to various wireless communication systems for transmitting downlink or uplink control information. In addition, the contents of the disclosure may be applied in an unlicensed band as well as a licensed band as needed.

In the disclosure, higher layer signaling or higher signaling may be a method for transmitting a signal to a UE from a base station using a downlink data channel of a physical layer or to a base station from a UE using an uplink data channel of a physical layer. According to an embodiment, the higher layer signaling may include at least one of radio resource control (RRC) signaling, signaling according to an F1 interface between a centralized unit (CU) and a distributed unit (DU), or a signal transmission method through a MAC control element (MAC CE). Additionally, according to an embodiment, the higher layer signaling or higher signaling may include system information commonly transmitted to multiple UEs, for example, a system information block (SIB).

In the 5G wireless communication system, a synchronization signal block (SSB) (also referred to as an SS block, an SS/PBCH block, etc.) may be transmitted for initial access, and the synchronization signal block may be composed of a primary synchronization signal (PSS), a secondary synchronization, signal (SSS), and a physical broadcast channel (PBCH). In the initial access step in which a UE initially accesses the system, the UE may obtain downlink time and frequency domain synchronization from a synchronization signal through a cell search procedure and also obtain a cell ID. The synchronization signal may include the PSS and the SSS. The UE may receive a PBCH including a master information block (MIB) from a base station and obtain system information related to transmission and reception, such as system bandwidth or related control information, and basic parameter values. The UE may obtain a system information block (SIB) by performing decoding on the physical downlink control channel (PDCCH) and the physical downlink shared channel (PDSCH) based on the received PBCH. Thereafter, the UE may exchange identity with the base station through a random access step and go through steps such as registration and authentication to initially access the network.

As described above, one slot may include 14 symbols, and in the 5G communication system, the uplink-downlink configuration of a symbol and/or a slot may be configured in three stages.

In the first method, the uplink-downlink of a symbol and/or a slot may be configured semi-statically through cell-specific configuration information via system information in symbol units. Specifically, the cell-specific uplink-downlink configuration information via the system information may include uplink-downlink pattern information and reference subcarrier information. The uplink-downlink pattern information may indicate a pattern periodicity, the number of consecutive downlink slots from the start point of each pattern, the number of symbols in the next slot, the number of consecutive uplink slots from the end of the pattern, and the number of symbols in the next slot. Slots and symbols that are not indicated as uplink and downlink may be determined as flexible slots/symbols.

In the second method, through user-specific configuration information via dedicated higher layer signaling, a flexible slot or a slot containing a flexible symbol may be indicated by the number of consecutive downlink symbols from the start symbol of the slot and the number of consecutive uplink symbols from the end of the slot, or indicated by a full downlink slot or a full uplink slot.

In the third method, in order to dynamically change the downlink signal transmission and uplink signal transmission intervals, each of the symbols indicated as flexible symbols (e.g., symbols not indicated as downlink or uplink) in each slot may be indicated as a downlink symbol, an uplink symbol, or a flexible symbol, through a slot format indicator (SFI) included in a downlink control channel. The slot format indicator may select one index from a table (e.g., 3GPP TS 38.213 Table 11.1.1-1) in which the uplink-downlink configuration of 14 symbols in one slot is preconfigured.

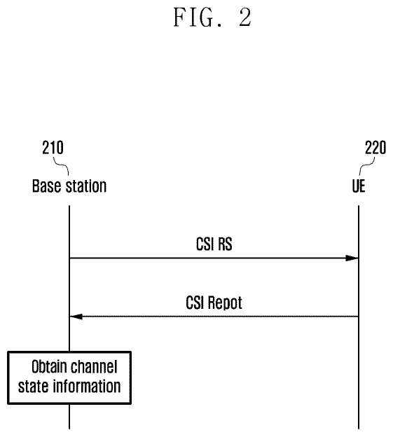

FIG. 2 illustrates a diagram of an estimation of a channel state between a base station and a UE by the base station in a wireless communication system according to an embodiment of the present disclosure.

The base station may efficiently transmit data by considering the radio conditions between the UE and the base station. For example, the base station may efficiently transmit data by applying a high data transfer rate in the case of good radio conditions and applying a low data transfer rate in the case of poor radio conditions.

As discussed above, in order to efficiently transmit data, there is a need to estimate a channel state between the base station and the UE. The channel state between the base station and the UE can be estimated based on, for example, a signal to interference and noise ratio (SINR). Specifically, when the SINR value is large, interference and noise are relatively small, so the channel state can be estimated to be good. Also, when the SINR value is small, interference and noise are relatively large, so the channel state can be estimated to be poor. The channel state can be reported by the UE.

In the disclosure, for convenience of expression, channel information may be expressed based on the SINR. Therefore, channel state information may include SINR information, and the SINR information may be used as an example of information for expressing the channel state.

With reference to FIG. 2, the base station 210 can obtain channel state information (CSI) between the base station 210 and the UE 220 based on a CSI report. Obtaining the channel state information between the base station 210 and the UE 220 based on the CSI report may follow the following process. The base station 210 transmits a CSI reference signal (CSI-RS) to the UE 220. Thereafter, the UE 220 measures the channel state information based on the CSI-RS and transmits the CSI report to the base station 210. The CSI report may include at least one of a rank indicator (RI), a precoding matrix indicator (PMI), channel quality information (CQI), and a CSI-RS resource indicator (CRI). The base station may obtain the channel state information based on the CQI and later transmit data to the UE based on a data transfer rate determined based on the estimated channel state. Some of the above processes may be omitted.

Hereinafter, for the convenience of explanation, the transmission of the CSI report from the UE 220 to the base station 210 may be referred to as a CSI feedback. Since the CSI report may include CQI-related information, the CSI report may also be referred to as a CQI report or CQI feedback. In addition, the CSI report may be transmitted from the UE 220 to the base station 210 at a cycle of, for example, 80 ms or 160 ms, and the CQI may be transmitted to the base station periodically or aperiodically and may be, for example, 4-bit information.

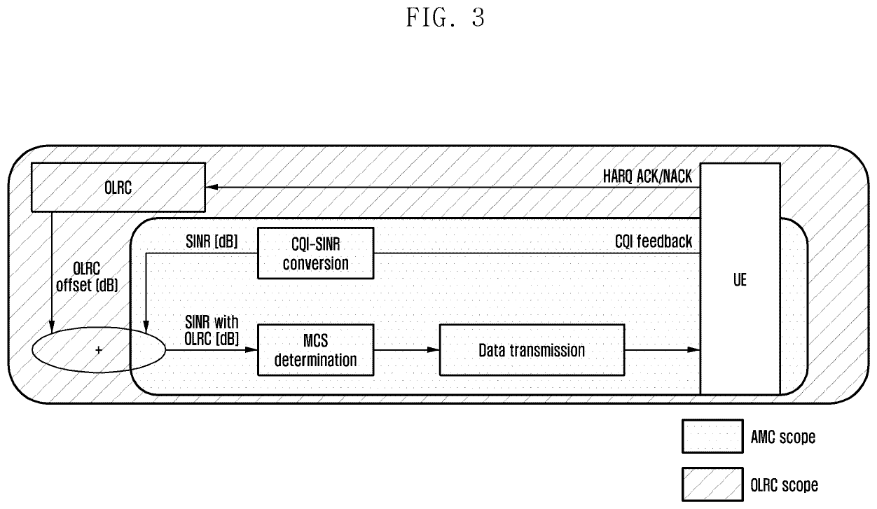

FIG. 3 illustrates a diagram of a transmission of data in relation to link adaptation in a wireless communication system according to an embodiment of the present disclosure.

The link adaptation may be a term that refers to matching modulation, coding, and other signal and protocol parameters to the conditions of a radio link. In other words, the link adaptation may be transmitting data by appropriately adjusting the amount of data transmitted according to channel conditions.

In the case of a UE moving in real time or a UE at the cell edge, the radio conditions between the UE and the base station may continuously change in time, which means that the state of the radio link may also continuously change in time, or that the channel state between the UE and the base station may continuously change in time.

Link adaptation technology is a technology used to adjust the amount of data transmitted based on appropriate parameters according to the radio link state or the channel state that changes over time, and thus transmit data without errors. At this time, the data transmitted may be downlink data transmitted from the base station to the UE, and the link adaptation may be to select an appropriate MCS according to the channel state and transmit data.

In the wireless communication system, before data is transmitted, the modulation scheme and error correction code coding rate of the data to be transmitted or the MCS level may be determined to suit the channel environment. The MCS level for data transmission in the wireless communication system may be implemented variously depending on the scheme. A representative MCS level implementation scheme may be based on a link application algorithm.

In relation to the link adaptation, the link adaptation algorithm may be used to dynamically adjust modulation and coding scheme (MCS) related parameters according to a temporally varying radio channel environment, thereby obtaining appropriate parameters suitable for the channel environment. That is, the link adaptation algorithm may be an algorithm used to select an appropriate MCS level.

The MCS may include a configuration that combines MCS related parameters, and the MCS related parameters may include a modulation scheme, a coding rate, the number of spatial streams, or a channel bandwidth. The modulation scheme may include binary phase shift keying (BPSK), quadrature phase shift keying (QPSK), 16-quadrature amplitude modulation (16-QAM), 64-quadrature amplitude modulation (64-QAM), etc. The coding rate may include ½, ¾, ⅚, etc. The number of spatial streams may be used up to 4. In addition, the channel bandwidth may include 20 MHz or 40 MHz. Meanwhile, the MCS level may be one from 0 to 31, and the base station may select an MCS level based on the channel state and select an appropriate modulation technique or coding scheme based on the MCS level or the MCS related parameters to transmit downlink data. In the disclosure, for convenience of explanation, selecting the MCS level may be expressed as selecting the MCS.

The link adaptation algorithm may include, for example, adaptive modulation and coding (AMC) or outer loop rate control (OLRC). Here, the AMC may be an example of the link adaptation algorithm based on channel state information (CSI) feedback, and the OLRC may be a term used interchangeably with outer loop rate adaptation (OLLA). In addition, the OLRC may be an example of the link adaptation algorithm based on hybrid automatic repeat and request (HARQ) acknowledgement (ACK)/negative acknowledgement (NACK) feedback.

The AMC may be a technology for determining an MCS level based on a CQI report received from the UE. In relation to the AMC technology, the base station may convert CQI received from the UE into SINR and determine the MCS level based on the converted SINR value. At this time, a method for converting CQI into SINR and a method for determining the MCS level based on the SINR value may be predefined. For example, a process for determining the MCS level based on the SINR value may be based on an MCS decision table including MCS level information for each channel state.

Meanwhile, determining the MCS level based on the AMC has some limitations. Specifically, considering that there is a possibility that the UE may transmit a somewhat inaccurate CQI value, and that there may be cases where the CQI is reported at a relatively long cycle of 80 ms or 160 ms, the MCS level determined using the AMC may be inaccurate. For reference, the reporting cycle of CQI may be 4 slots, 5 slots, 8 slots, 10 slots, 16 slots, 20 slots, 32 slots, 40 slots, 64 slots, 80 slots, 160 slots, 320 slots, or 640 slots.

The OLRC may be an MCS level determination scheme to complement the limitations of the AMC-based MCS level determination scheme. The OLRC is similar to the AMC in that it converts the CQI received from the UE into SINR. However, the OLRC differs from the AMC in that it additionally corrects the SINR estimated from the CQI by using the HARQ ACK/NACK signal received from the UE. Specifically, in the case of the OLRC, the SINR value is continuously corrected by upwardly adjusting the converted SINR value in response to an ACK signal received from the UE and downwardly adjusting the converted SINR value in response to a NACK signal received from the UE. The SINR value corrected in the OLRC process may be an OLRC offset, and the OLRC parameter may include AckStepSize or NackStepSize.

The OLRC-based MCS level determination scheme that continuously corrects the SINR value can complement the limitations of the AMC-based MCS level determination scheme mentioned above in that it can determine an appropriate MCS level by correcting the SINR value even when a somewhat inaccurate CQI is received from the UE or a significant change in the channel state occurs immediately after CQI reception.

Meanwhile, in relation to MCS level determination, the base station may determine an MCS level corresponding to the SINR determined based on the OLRC by referring to an MCS decision table including preconfigured MCS level information for each channel state, and transmit data based on the MCS level.

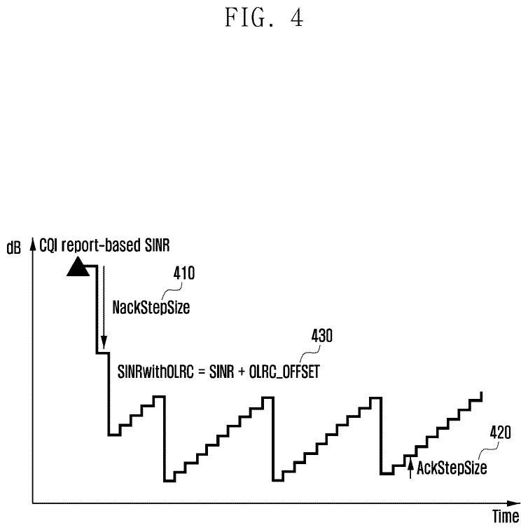

A detailed OLRC-based SINR correction process is as shown in FIG. 4.

FIG. 4 illustrates a diagram of an OLRC-related SINR correction process in a wireless communication system according to an embodiment of the present disclosure.

As discussed above, the OLRC may be a scheme of converting a CQI value reported from the UE into SINR, continuously correcting the converted SINR value, and determining an MCS level based on the corrected SINR value. The OLRC-based MCS level determination scheme may include the following process.

The base station may receive a CQI value report from the UE. The base station may convert the CQI value reported from the UE into an SINR value and determine an MCS level based on the converted SINR value. Thereafter, the base station may transmit downlink data to the UE based on the determined MCS level. In addition, the base station may downwardly adjust the SINR value if a response signal of the corresponding downlink data is NACK, and it may upwardly adjust the SINR value if the response signal of the downlink data is ACK. The SINR value may be continuously updated through the response signal of the downlink data, and the MCS level may be determined based on an appropriate SINR value. In this case, the SINR value corrected in the OLRC process may be an OLRC offset 430.

In relation to FIG. 4, the size of the downwardly adjusted SINR correction amount may be NackStepSize 410, and the size of the upwardly adjusted SINR correction amount may be AckStepSize 420. These NackStepSize 410 and AckStepSize 420 may be adjusted during the SINR correction process, and adjusting the size of the SINR correction amount may allow a block error rate (BLER) of data transmitted from the base station to converge to the target BLER. In addition, if the SINR correction process is sufficiently performed through the OLRC, the SINR value converges to a specific SINR value, and the MCS may be determined based on the converged SINR value. In the disclosure, the statement that the MCS is determined through the OLRC may mean that the MCS is determined based on the SINR that has undergone a sufficient correction process based on the OLRC.

In relation to FIG. 4, since the UE can send the HARQ ACK/NACK of the PDSCH that was made in a slot configured as downlink in a slot configured as uplink, it sends all together the HARQ ACK/NACK of the PDSCH received after the previous uplink. The OLRC of the base station upwardly adjusts the SINR by the number of received ACKs*ACKstepsize 420 and downward adjusts the SINR by the number of NACKs*NACKstepsize 410, thus finally determining the SINR. This process is represented as Equation 1 below.

$$SINR\_Final = SINR + OLRCoffset \qquad [ Equation 1 ]$$

$$OLRCoffset = OLRCoffset + Number of ACKs * ACKstepsize - Number of NACKs * Nackstepsize$$

For example, in the case of a time division duplexing (TDD) 4:1 communication system, the HARQ ACK/NACK of the PDSCHs made in four downlink D slots is transmitted in one uplink U slot. Hereinafter, the TDD 4:1 communication system may be a communication system characterized in that, with respect to slot configuration, four consecutive slots out of five consecutive slots may be configured to include only downlink (DL) symbols and the remaining one slot may be configured to include only uplink (UL) symbols.

In this regard, it is assumed that PDSCH transmissions were performed in all four D slots and that HAQK ACK/NACK reports for the transmission results were received as ACK, NACK, ACK, and ACK in one U slot. In this case, the OLRC can calculate the final predicted SINR based on Equation 2 below.

$$\begin{matrix}SINR\_Final = SINR + OLRCoffset \\ OLRCoffset = OLRCoffset + 3 * ACKstepsize - Nackstepsize\end{matrix} \qquad [ Equation 2 ]$$

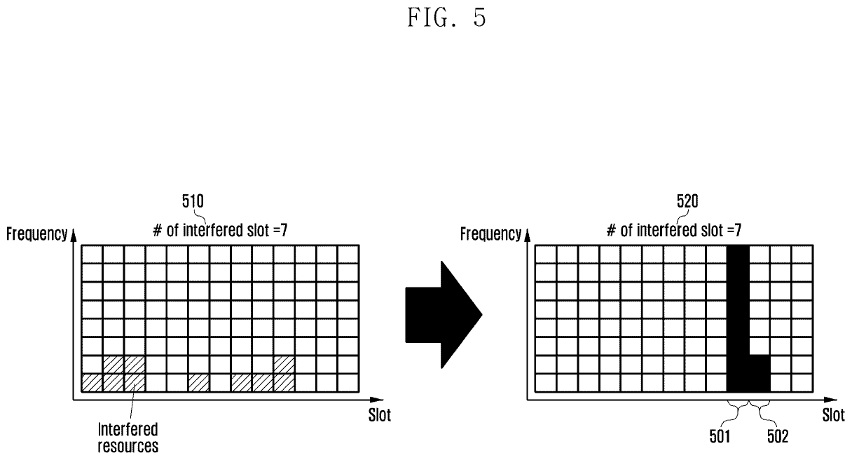

FIG. 5 illustrates a diagram of an example of radio resource allocation in the case of configuring an aggregated slot in a wireless communication system according to an embodiment of the present disclosure.

The description of FIG. 5 is based on the assumption that the OLRC-based MCS level determination method is used. With reference to FIG. 5, the horizontal axis represents the time domain, and the vertical axis represents the frequency domain. The unit of division in the time domain is a slot, and the unit of division in the frequency domain is a subcarrier.

Among the radio resources allocated in the serving cell, there are radio resources (i.e., interfered resources) that suffer interference from traffic of adjacent cells. Traffic of adjacent cells that acts as interference to the serving cell may be distributed and exist across multiple slots. With reference to FIG. 5, in the case 510 where no aggregated slot is configured, radio resources that are interfered with by traffic from adjacent cells may be distributed across a total of 7 slots based on the time axis.

According to an embodiment of the disclosure, in order to control inter-cell interference, a specific slot to which traffic of adjacent cells will be aggregated and allocated can be configured in the time domain. This specific slot of the time domain may be referred to as an aggregated slot or an interference aggregated slot. When the aggregated slot is configured, traffic transmitted in a certain section can be aggregated in and allocated to the aggregated slot.

An aggregated slot management apparatus can preconfigure the aggregated slot and transmit information on the aggregated slot to the whole cells. Therefore, the positions of the aggregated slots of the cells managed by the aggregated slot management apparatus can be aligned identically. Specifically, the aggregated slot for each cell can include the same operation section and offset configuration.

According to an embodiment, the radio resources to which the traffic of the cell is allocated may be aggregated in the preconfigured aggregated slot for scheduling. With reference to FIG. 5, in the case 520 where the aggregated slot is configured, the radio resources to which the traffic of the cell is allocated may be distributed over a total of two slots 501 and 502 based on the time axis. In this case, the frequency of slots to which nothing is allocated, i.e., slots to which no traffic is allocated, may increase.

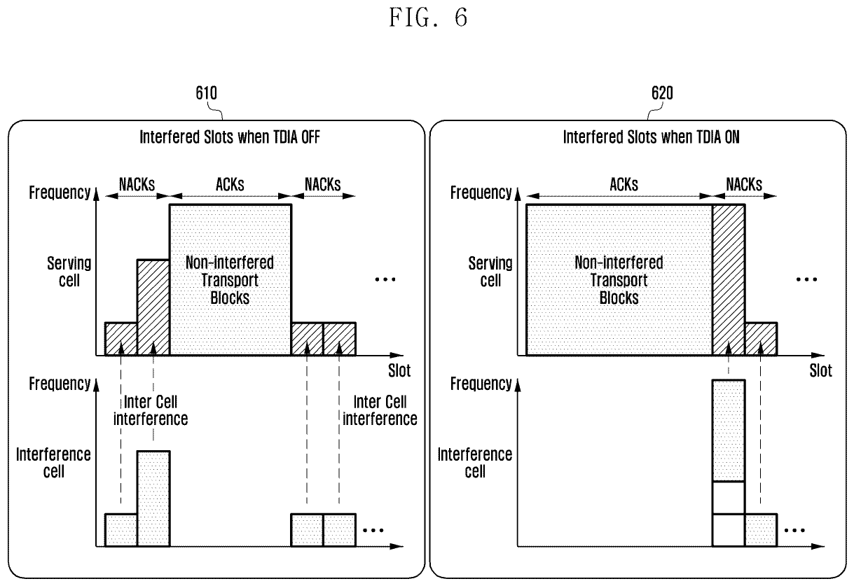

FIG. 6 illustrates a diagram of an example of radio resource allocation, divided by whether TDIA is applied, in the case of configuring an aggregated slot in a wireless communication system according to an embodiment of the present disclosure.

The description of FIG. 6 is based on the assumption that the OLRC-based MCS level determination method is used. With reference to FIG. 6, the horizontal axis of the graph represents the time domain, and the vertical axis represents the frequency domain. The unit of division in the time domain is a slot, and the unit of division in the frequency domain is a subcarrier.

According to an embodiment, the aggregated slot management apparatus may configure cell traffic to be aggregated and allocated to a specific slot in the time domain. In this case, the specific slot in the time domain may be referred to as an aggregated slot. Cells managed by the aggregated slot management apparatus may aggregate and allocate cell traffic to the aggregated slot based on information on the aggregated slot. The operation of the aggregated slot management apparatus for configuring the aggregated slot to control inter-cell interference in the time domain may be referred to as time domain interference slot alignment (TDIA).

The aggregated slot management apparatus can preconfigure the aggregated slot and transmit information on the aggregated slot to the whole cells. Therefore, the positions of the aggregated slots of the cells managed by the aggregated slot management apparatus can be aligned identically. Specifically, the aggregated slot for each cell can include the same operation section and offset configuration.

With reference to FIG. 6, if the aggregated slot is not configured, traffic randomly distributed in a cell adjacent to the serving cell and causing inter-cell interference may affect the serving cell. The serving cell may be affected by interference in accordance with the slots where the traffic is distributed within the adjacent cell. On the other hand, if the aggregated slot is configured, the traffic of a cell may be aggregated and allocated to the aggregated slot of the cell. If the traffic of an adjacent cell that causes interference is aggregated and allocated to the aggregated slot, the section of non-aggregated slots where traffic causing interference to the cell is not allocated may be longer. The non-aggregated slot means a slot other than the configured aggregated slot, and may be a slot in which the possibility of occurrence of cell-to-cell interference is low.

In FIG. 6, compared to the case 610 where TDIA does not operate, in the case 620 where TDIA operates, the serving cell can transmit to the UE more slots in which traffic not causing interference exists. Thus, the serving cell can obtain the effect of being less affected by inter-cell interference of the interfering cell.

That is, when the aggregated slot is configured, the probability of inter-cell interference of adjacent cells increases in the aggregated slot, but the probability of inter-cell interference of adjacent cells decreases in other slots (i.e., non-aggregated slots). This makes it possible to distinguish between time zones in which the probability of inter-cell interference occurrence is high and time zones in which it is low.

In addition, when the aggregated slot is configured, the cell may schedule traffic to be transmitted in a certain section to the configured aggregated slot. Specifically, when traffic occurs, the cell may wait without transmitting the traffic until it reaches the configured aggregated slot. Since such traffic may act as interference to adjacent cells, it may be aggregated in and allocated to the aggregated slot and transmitted to the UE. In other words, the traffic may be delayed in transmission until it reaches the aggregated slot and may not be transmitted to the UE.

Furthermore, when traffic cannot be allocated to the aggregated slot anymore, traffic may be allocated to the next slot of the aggregated slot. At this time, the next slot of the aggregated slot may be the non-aggregated slot.

When traffic is transmitted without the aggregated slot being configured, the probability of inter-cell interference exists randomly for each slot. On the other hand, when traffic is transmitted in the aggregated slot, the probability of inter-cell interference of adjacent cells is high in the aggregated slot and the probability of inter-cell interference of adjacent cells is low in the non-aggregated slot. So, it is possible to distinguish between time zones with high and low probabilities of inter-cell interference occurring. In addition, even if the size of the RB of interference is larger, the effect on the decoding performance of the CB may not be large. In other words, even if the size of the RB acting as interference increases by configuring the aggregated slot, the adverse effect on the throughput of data transmission is small, and rather, the number of slots acting as interference decreases, so that it is possible to obtain the effect of improving the performance of data transmission as the total amount of interference is reduced.

According to an embodiment, since the probability of inter-cell interference occurrence is high in the aggregated slot, the aggregated slot and a slot other than the aggregated slot (i.e., non-aggregated slot) can be classified as separate groups. If the aggregated slot, in which traffic of adjacent cells that acts as interference is aggregated and allocated, and the non-aggregated slot are classified as separate groups and signal transmission-related configuration is performed for signal transmission, the probability of inter-cell interference occurrence can be indirectly reduced.

The base station can separately apply the above-described OLRC method to each of the aggregated slot and the non-aggregated slot. That is, the base station can increase a signal to interference noise ratio (SINR) of the aggregated slot if the past transmission in the aggregated slot is ACK, and decrease the SINR if NACK. Also, the base station can increase the SINR of the non-aggregated slot if the past transmission in the non-aggregated slot is ACK, and decrease the SINR if NACK. The SINR can be increased by increasing the strength of the received signal of uplink.

The MCS level is selected based on the SINR of a channel where data transmission and reception are performed. A low MCS level is applied to the aggregated slot, and a high MCS level is applied to the non-aggregated slot. That is, a low data rate can be applied to the aggregated slot where inter-cell interference is expected to occur frequently.

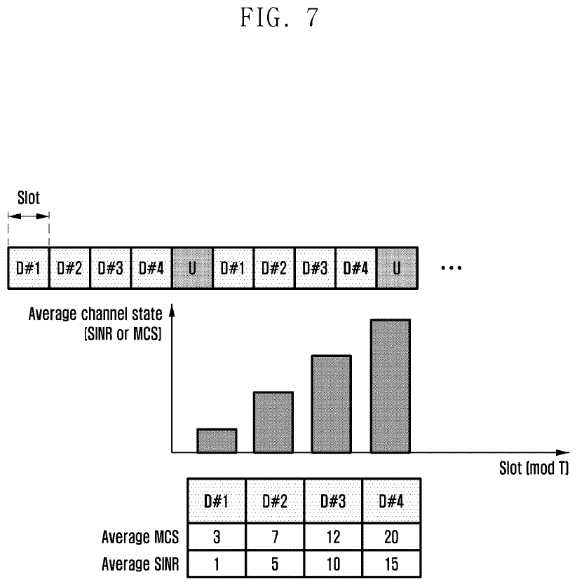

FIG. 7 illustrates a diagram of an average channel state per slot and an optimal MCS per slot in a time division duplexing (TDD) 4:1 wireless communication system according to an embodiment of the present disclosure.

FIG. 7 shows an example of the average channel state per slot and the optimal MCS per slot in the case where TDIA operates and the first downlink slot after the uplink slot is selected as the aggregated slot in the TDD 4:1 communication system.

Hereinafter, the average channel state per slot may refer to an average channel state per slot index. For convenience of explanation, a downlink slot which appears nth after an uplink slot may be expressed as the nth downlink slot or D #n. In addition, the average channel state of the nth slots may indicate the average channel state of D #n. In this case, ‘n’ may be 1, 2, 3, or 4 in the TDD 4:1 communication system, and for example, the average channel state of the first slots may indicate the average channel state of D #1.

In FIG. 7, if the aggregated slot is the first downlink slot (D #1), a lot of traffic may be transmitted in the first downlink slot. In addition, if traffic cannot be completely transmitted in the first downlink slot (D #1), remaining traffic which is not transmitted in the first downlink slot (D #1) may be transmitted in the second downlink slot (D #2). Similarly, if there is remaining traffic not transmitted in the second downlink slot (D #2), the remaining traffic may be sequentially transmitted in the third downlink slot (D #3) and the fourth downlink slot (D #4).

Considering the purpose of configuring the aggregated slot and the fact that if some traffic is not transmitted, it will be transmitted in the next slot, on average, the most traffic will be transmitted in D #1, and the less traffic will be transmitted as it goes from D #2 to D #3 and D #4. Therefore, the interference from adjacent cells may have the greatest effect in the first downlink slot (D #1) and may have the smallest effect in the fourth downlink slot (D #4).

For example, in FIG. 7, the SINR value of D #1 is 1, the SINR value of D #2 is 5, the SINR value of D #3 is 10, and the SINR value of D #4 is 15, so it can be seen that the interference from adjacent cells has the greatest effect in D #1. As the interference becomes more significant, it is more efficient to reduce the amount of data transmission by configuring a smaller MCS value. As a result, it can be seen that the average MCS of D #1 is the smallest at 3, and the average MCS value increases as going to D #2 (MCS: 7), D #3 (MCS: 12), and D #4 (MCS: 20).

In summary of the above, in the case where the aggregated slot is configured, interference is greatest in the aggregated slot and is also greater in slots after the aggregated slot as they are closer to the aggregated slot. That is, it can be inferred that there is a difference in channel characteristics for each slot.

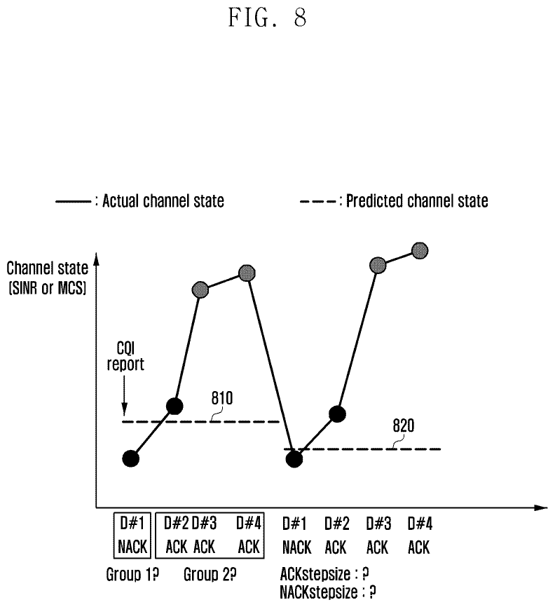

FIG. 8 illustrates a diagram of an actual channel state per slot and a channel state predicted by a base station in a wireless communication system according to an embodiment of the present disclosure.

FIG. 8 shows a situation where, in the TDD 4:1 communication system, it was planned to operate D #1 as the aggregated slot and D #2, D #3 and D #4 as the non-aggregated slots, but traffic of the current interference cell was more than expected, so it could not be fully processed in D #1 and was shifted to D #2. For example, if the amount of traffic that can be processed in D #1, which is planned to be operated as the aggregated slot, is 50, but the amount of traffic of the current interference cell is 80, all the traffic of 80 cannot be processed in D #1 and the remaining traffic of 30 is transferred to D #2. In addition, it is assumed that the base station is operating the same link adaptation without slot distinction and that the initial OLRC parameter is configured with NACKstepsize=8*ACKstepsize.

With reference to FIG. 8, it can be seen that D #1 and D #2 have somewhat poor channel states while D #3 and D #4 have better channel states. However, in the case of the TDD 4:1 communication system, since the OLRC operates in four downlink cycles, the base station may predict that D #1, D #2, D #3 and D #4 all have the same channel state 810, and based on this, may determine the same MCS for all slots. In this case, 810 may indicate a channel state estimated based on the CQI report received from the UE.

As a result, unlike D #2, D #3, and D #4, in the case of D #1, a large MCS value is determined compared to the channel state, so the UE may not be able to smoothly receive a downlink signal via D #1. Thus, the base station may receive NACK, ACK, ACK, and ACK in the U slot, and predict the channel state of the D slot of the next cycle as shown in Equation 3 below.

$$\begin{matrix}SINR\_Final = SINR + OLRCoffset \\ OLRCoffset = OLRCoffset + 3 * ACKstepsize - Nackstepsize \\ = OLRCoffset - 5 * ACKstepsize\end{matrix} \qquad [ Equation 3 ]$$

Therefore, the base station may downwardly adjust the predicted channel state to 820 in the next four D slots. However, in this case, the transmission in slot D #1 will still fail, and the predicted channel state will be further down-adjusted. This process is repeated so that eventually the channel state predicted by the base station may converge to be similar to the channel state of D #1. However, in slots D #2, D #3, and D #4, data is transmitted with a lower MCS than the channel states of that slots, which may result in a significant loss in terms of the system throughput.

Due to these problems, a method may be considered in which slots are classified into groups and group-based OLRC is performed to determine an appropriate MCS for each group. For example, the base station may classify downlink slots into a first group ([D #1]) and a second group ([D #2, D #3, D #4]) and perform the group-based OLRC to determine MCS per group. For example, in the group-based OLRC, the OLRC for the first group may refer to determining an MCS level by correcting SINR based on HARQ ACK/NACK for D #1, and the OLRC for the second group may refer to determining an MCS level by correcting SINR based on HARQ ACK/NACK for D #2, D #3 and D #4.

In the disclosure, performing the group-based OLRC may have the same meaning as separately operating link adaptation.

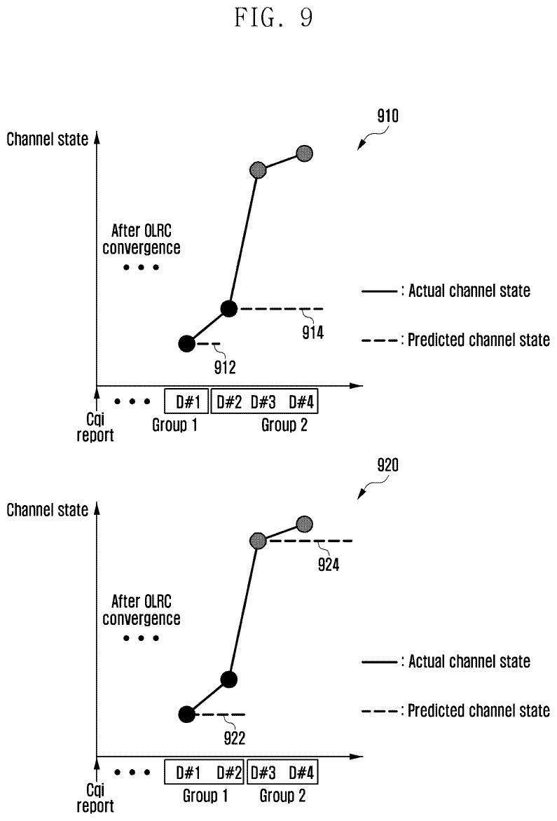

FIG. 9 illustrates a diagram of a process of performing group-based OLRC in a wireless communication system according to an embodiment of the present disclosure.

In FIG. 9, reference numeral 910 indicates that D #1 belongs to the first group and D #2, D #3 and D #4 belong to the second group to perform the ORLC for each group and determine an appropriate MCS for each group. In addition, reference numeral 920 indicates that D #1 and D #2 belong to the first group and D #3 and D #4 belong to the second group to perform the ORLC for each group and determine an appropriate MCS for each group.

In FIG. 9, determining the MCS refers by performing the OLRC may refer to determining the MCS based on SINR that has undergone sufficient correction process based on the OLRC. In addition, determining an appropriate MCS for each group may refer to estimating the channel state for each group and, based on this, determining an appropriate MCS level.

In the case of 910, the base station predicted channel state, initially determined based on the CQI report, is modified multiple times based on the HARQ ACK/NACK results, so the base station predicted channel state for the first group (D #1) converges to 912, and the base station predicted channel state for the second group (D #2, D #3 and D #4) converges to 914.

In the case of 910, the channel state 914 predicted by the base station in D #2, D #3 and D #4 is close to D #2, so although transmission is successful in D #3 and D #4, a low MCS is transmitted compared to the channel states of the slots, resulting in a significant loss in terms of system throughput.

In the case of 920, the base station predicted channel state, initially determined based on the CQI report, is modified multiple times based on the HARQ ACK/NACK results, so the base station predicted channel state for the first group (D #1 and D #2) converges to 922, and the base station predicted channel state for the second group (D #3 and D #4) converges to 924.

In the case of 920, although a slightly lower MCS is transmitted compared to the channel states of D #2 and D #4, there is no significant loss in terms of system throughput compared to the case of 910.

In summary of the above contents of FIG. 9, it can be expected that separating slots into appropriate groups and performing the OLRC for each group to determine the MCS is important for efficient data transmission.

Meanwhile, for appropriate group separation, it can be considered to create one group for aggregated slots and another group for non-aggregated slots and perform the OLRC on each group. This is because the base station can expect that the channel states of aggregated slots are similar and that the channel states of non-aggregated slots are also similar.

However, it may only be a base station's expectation that the channel states will be similar within each of the aggregated slot group and the non-aggregated slot group and that there will be a large difference in the channel states between the aggregated slot group and the non-aggregated slot group. This may not be the case depending on the actual channel state and the traffic conditions.

For example, depending on the actual traffic amount of the current interference cell, there may be less traffic and interference in the aggregated slot than expected, so the difference in channel states with other slots may not be significant, or conversely, slots configured as non-aggregated slots may also have poor channel states due to traffic exceeding the aggregated slot. Inappropriate group separation not only leads to incorrect channel prediction with unhelpful HARQ ACK/NACK, but also results in a reduction in HARQ ACK/NACK samples. This may rather cause inefficient data transmission compared to performing the OLRC without group separation.

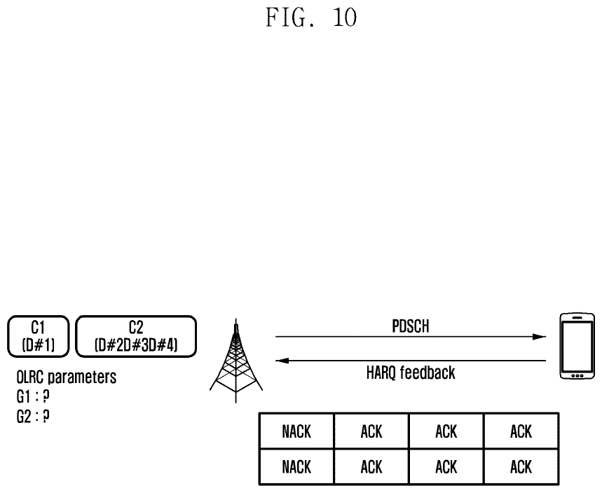

FIG. 10 illustrates a diagram of a method for a base station to group slots in the case where there is no report from a UE regarding channel information per slot in a wireless communication system according to an embodiment of the present disclosure.

FIG. 10 shows a situation in which the base station performs grouping only with scheduling operation information (e.g., information that D #1 is operated as the aggregated slot) and HARQ ACK/NACK information when there is no UE's report on channel information per slot in the TDD 4:1 communication system. With only the plan to operate D #1 as the aggregated slot and the HARQ ACK/NACK information received from the UE, inappropriate grouping may be performed as a result of channel estimation that does not match the actual channel state. Performing the OLRC with inappropriate groups may result in less efficient data transmission than performing the OLRC without grouping. In addition, considering that there is no basis for configuring group-based OLRC parameters when there is no UE's report on channel information per slot, there may be difficulties in performing the group-based OLRC.

Meanwhile, the slot-related channel information (channel information per slot) may be channel information according to a value determined based on the modulo operation of a slot index for each of at least one or more slots. In addition, the slot-related channel information may include at least one of an average interference of a plurality of slots having the same value, an average relative interference difference (or differential average interference), a variance interference, an interference standard deviation (or std interference), an average SINR estimated based on DMRS (or average SINR demodulation), an average relative SINR difference estimated based on DMRS (or differential average SINR demodulation), a variance of SINR values estimated based on DMRS (or variance SINR demodulation), or a standard deviation of SINR values estimated based on DMRS (or std SINR demodulation).

Additionally, the slot-related channel information may be updated in response to reception of downlink data. For example, the slot-related channel information may be updated whenever downlink data is received.

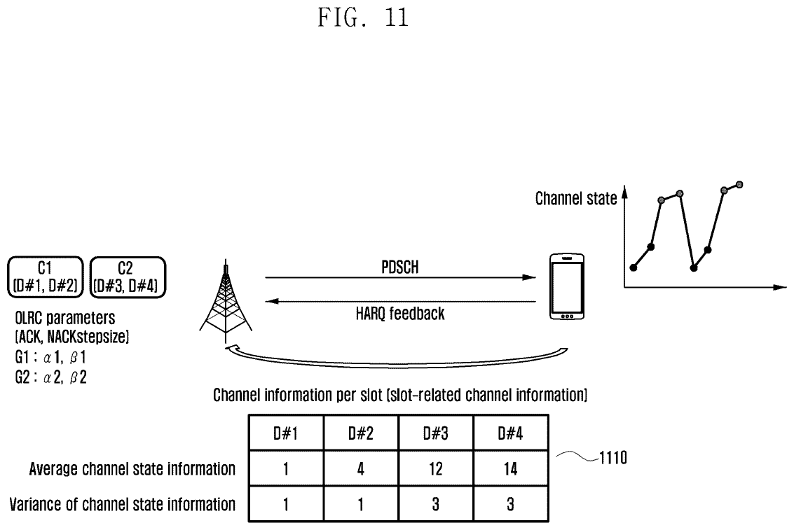

FIG. 11 illustrates a diagram of a method for a base station to group slots based on a report from a UE regarding channel information per slot in a wireless communication system according to an embodiment of the present disclosure.

In the disclosure, the channel information per slot has the same meaning as the slot-related channel information and they may be used interchangeably. In FIG. 11, whenever the UE receives downlink data, it may continuously update the channel information per slot (i.e., the slot-related channel information) and report the channel information per slot to the base station through uplink control information. Based on the received channel information per slot, the base station may perform the group-based OLRC by classifying slots with similar average channel states into the same group. In addition, the channel information per slot received from the UE can help determine OLRC parameters.

The channel information per slot may include average channel state information per slot and a variance of channel state information per slot, and the OLRC parameters may include ACKsteptize and NACKstepsize. The average channel state information per slot may be information that serves as a criterion for determining the average channel state of D #n.

For example, as shown in FIG. 11, when the channel information per slot denoted by 1110 is received from the UE, the base station can see that the average channel state information of D #1 and D #2 are similar as 1 and 4, the average channel state information of D #3 and D #4 are similar as 12 and 14, and the variance of the channel state information per slot is not large. Based on the above, the base station may configure D #1 and D #2 having similar average channel state information as one group, and configure D #3 and D #4 having similar average channel state information as another group. In addition, the channel information per slot may be used to appropriately determine the OLRC parameters. For example, when the variance of the channel state information is large, the OLRC parameter values ACKsetpsize and NACKstepsize may be determined as small values. The case of performing the OLRC per group based on appropriate grouping may enable more efficient data transmission than the case of failing to receive the channel information per slot from the UE.

In summary, it can be inferred that when the base station receives the average channel information per slot from the UE, more efficient data transmission and reception is possible between the base station and the UE than when it does not.

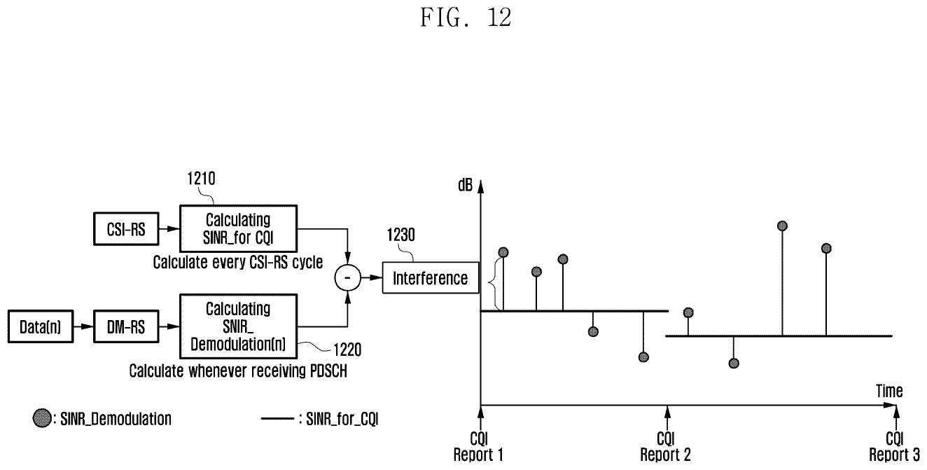

FIG. 12 illustrates a diagram of a method for obtaining interference amount related information in a wireless communication system according to an embodiment of the present disclosure.

As described above, the channel information per slot may include the average channel state information per slot and the variance of channel state information per slot. The average channel state information per slot may include all of the average channel state information of the first slot, the second slot, the third slot, or the fourth slot. For example, the average channel state information of the first slot may be an average value of the channel state information of D #1, and D #1 may be a downlink-configured slot that appears first after an uplink-configured slot.

The average channel state information per slot and the variance of the channel state information per slot may be expressed by various indicators including the SINR or the amount of interference. In the following description, the amount of interference received during downlink data transmission may be used as an example for expressing the average channel state information per slot and the variance of the channel state information per slot. However, the interference amount may only be an example for expressing the average channel state information per slot, etc., and the channel state information per slot in the disclosure may not be described based on the interference amount. In the examples below, the relative interference amount and the interference amount may be used with the same meaning.

In relation to FIG. 12, the UE may calculate and store the relative interference amount and the variance or standard deviation of the interference amount whenever it receives the downlink data transmission from the base station. Upon receiving the nth downlink data transmission, the UE may calculate the nth relative interference amount (Interference (n)) 1230 based on a difference between the SINR (SINR_{for}_{_{CQI(n)}}) 1210 estimated by the previous CSI-RS and the SINR (SINR_Demodulation(n)) 1220 estimated based on the DM-RS in the PDSCH, and store the calculated value. Equation 4 expresses a method for calculating the relative interference amount.

$$Interference ( n ) = SINR\_for \_CQI ( n ) - SINR\_Demodulation ( n ) \qquad [ Equation 4 ]$$

The slot index (Transmission_PDSCH_SlotIndex (n)) of the nth downlink data transmission may be calculated using Equation 5 and stored. In Equation 5, ‘T’ denotes a slot count period. In the 4:1 TDD communication system, ‘T’ may be 5, and the possible slot index may be one of 1, 2, 3, and 4.

$$Transmission\_PDSCH \_SlotIndex ( n ) = mod ( SlotNumber ( n ) , T ) \qquad [ Equation 5 ]$$

Based on the interference amount calculated using the above method, the average interference amount per slot and the interference fluctuation indicators (variance and standard deviation) may be updated. Using interference amount data of a certain sample, the average interference amount (Average_interference) for each slot index may be calculated as in Equation 6.

$$Average\_interference ( Slot\_index ) = Average ( interference ( Transmission\_PDSCH \_SlotIndex ( end - windowsize + 1 : end ) == Slot\_index ) ) \qquad [ Equation 6 ]$$

Also, in case of desiring to know only the average relative interference difference (Differential_Average_interference) between slots, it may be obtained as in Equation 7.

$$Differential\_Average \_interference = Average\_interference - min ( Average\_interference ) \qquad [ Equation 7 ]$$

Also, interference variance (Variance_interference) and standard deviation (Std_interference) for each slot index may be calculated and stored using interference amount data of a certain sample as in Equation 8.

$$Variance\_interference ( Slot\_Index ) = Variance ( interference ( Transmission\_PDSCH \_SlotIndex ( e nd - windowsize + 1 : end ) == Slot\_index ) ) \qquad [ Equation 8 ]$$

$$STD\_interference ( Slot\_Index ) = Std ( interference ( Transmission\_PDSCH \_SlotIndex ( end - windowsize + 1 : end ) == Slot\_index ) )$$

In a similar manner to the method of calculating the average interference amount for each slot index, the average relative interference difference (differential average interference) between slots, the variance of interference amounts, or the standard deviation of interference amounts, it is possible to calculate the average SINR for each slot index, the average relative SINR difference (differential average SINR demodulation), the variance of SINR values, or the standard deviation of SINR values may be calculated as in Equation 9. In this case, the SINR value may be a value estimated based on DMRS.

$$Average\_SINR \_Demodulation ( Slot\_Index ) = Average ( SINR\_Demodulation ( Transmission\_PDSCH \_Slotlndex ( end - windowsize + 1 : end ) == Slot\_index ) ) \qquad [ Equation 9 ]$$

$$Differential\_Average \_SINR \_Demodulation = Average\_SINR \_Demodulation - min ( Average\_SINR \_Demodulation )$$

$$Variance\_SINR \_Demodulation ( Slot\_Index ) = Variance ( SINR\_Demodulation ( Transmission\_PDSCH \_SlotIndex \\ ( end - windowsize + 1 : end ) == Slot\_index ) )$$

$$Std\_SINR \_Demodulation ( Slot\_Index ) = St d ( SINR\_Demodulation ( Transmission\_PDSCH \_SlotIndex ( end - windowsize + 1 : end ) == Slot\_index ) )$$

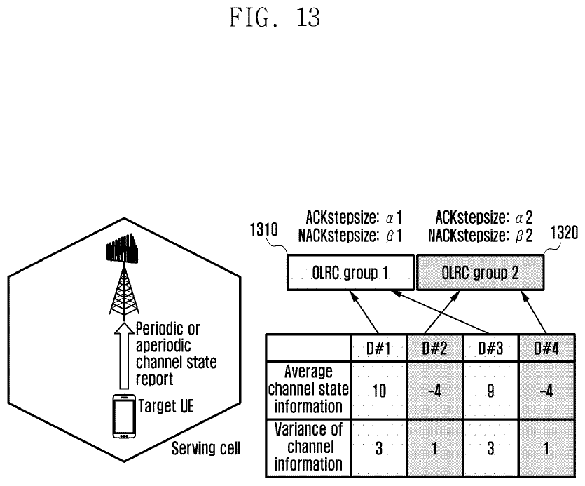

FIG. 13 illustrates a diagram of a method for a UE to report channel information per slot to a base station without a report request from the base station in a wireless communication system according to an embodiment of the present disclosure.

The following description regarding FIG. 13 is not limited to the case where there is no report request from the base station, and may also be applied to the case where there is a report request from the base station.

The base station can classify slots into appropriate groups for OLRC by using the received channel information per slot. By doing so, the base station can separately perform link adaptation operation for each slot group. At this time, separate link adaptation operation for each slot group refers to performing the OLRC for each group to determine an appropriate MCS value for each group.

Meanwhile, before measuring channel information of each slot, the UE can receive from the base station a reference signal to be used for measuring the channel information of each slot including DMRS related to PDSCH reception. In the case of receiving downlink data, the UE can measure the channel information of each slot based on the reference signal. The channel information of each slot measured by the UE may include, for example, the amount of interference, which may be calculated based on the channel information or SINR value of each slot measured by the UE.

FIG. 13 shows an example of a situation in which the UE searches for average channel state information and variance of channel state information according to each slot and reports them to the base station periodically or aperiodically. In this example, the average channel state information of D #1 and D #3 are 10 and 9, respectively, and the average channel state information of D #2 and D #4 are −4 and −4, respectively. In this example, the average channel state information may be information based on interference amount per slot.

In FIG. 13, the base station can perform group-based OLRC by setting D #1 and D #3 having similar average channel states to the first group 1310 and setting D #2 and D #4 to the second group 1320, and determine an MCS value for each groupbased on this. In addition, the base station may determine OLRC ACK/NACK stepsize per group based on the variance of channel state information.

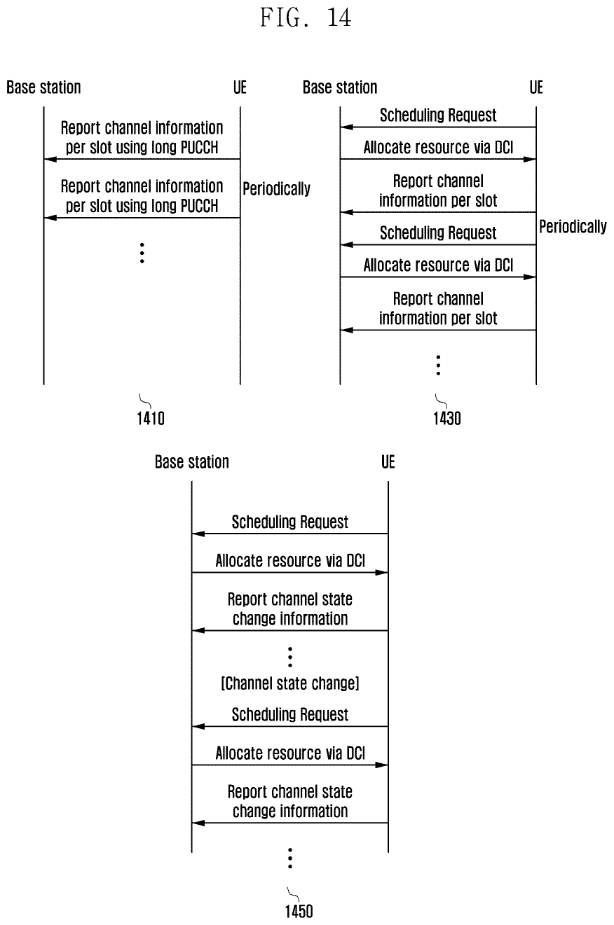

FIG. 14 illustrates a diagram of a method for a UE to report channel information per slot to a base station periodically or aperiodically without a report request from the base station in a wireless communication system according to an embodiment of the present disclosure.

The following description regarding FIG. 14 is not limited to the case where there is no report request from the base station, and may also be applied to the case where there is a report request from the base station.

In relation to FIG. 14, the UE may report the channel information per slot, including the average channel state information and the variance of channel state information, to the base station periodically or aperiodically. Reference numerals 1410 and 1430 show the cases where the UE periodically reports the channel information per slot to the base station, and reference numeral 1450 shows the case where the UE aperiodically reports the channel information per slot to the base station.

In addition, the case 1410 shows that the UE reports the channel information per slot periodically using a long PUCCH. Even without a report request from the base station, the UE can periodically report to the base station the channel information per slot obtained based on channel information for each measured slot.

In relation to the case 1410, the channel information per slot may be transmitted based on a UCI field. UCI may be transmitted via the long PUCCH.

Meanwhile, in the disclosure, the UCI may include a field indicating a slot index value and a field indicating channel information of a slot index corresponding to the slot index value.

In relation to the case 1410, the channel information for each slot may be information including the interference amount of each slot, and may be information measured for each slot based on a reference signal received by the UE from the base station. In addition, the channel information per slot transmitted to the base station may include channel state change information.

In the case 1430, the UE may periodically transmit a scheduling request (SR) to the base station, receive resource allocation from the base station through DCI, and report the channel information per slot based on the allocated resource. The channel information per slot may be reported using PUSCH or PUCCH.

In relation to the case 1430, the channel information per slot may be transmitted based on the UCI field. The UCI may be transmitted via PUSCH or PUCCH.

In relation to the case 1430, the channel information for each slot may be information including the interference amount of each slot, and may be information measured for each slot based on a reference signal received by the UE from the base station. In addition, the channel information per slot transmitted to the base station may include channel state change information.

In the case 1450, the UE may aperiodically transmit the SR to the base station, receive resource allocation from the base station through DCI, and report the channel information per slot based on the allocated resource. The channel information per slot may be reported using PUSCH or PUCCH.

Unlike the case 1430, in the case 1450, the UE may not periodically transmit the SR to the base station, but may transmit the SR when a change in the channel state exceeds a threshold value. In this case, the channel state may be operated in a window scheme to check whether a change in the channel state exceeds a threshold value.

In relation to the case 1450, the channel information per slot may be transmitted based on the UCI field. The UCI may be transmitted via PUSCH or PUCCH.

In relation to the case 1450, the channel information for each slot may be information including the interference amount of each slot, and may be information measured for each slot based on a reference signal received by the UE from the base station. In addition, the channel information per slot transmitted to the base station may include channel state change information.

In relation to FIG. 14, the following fields may exist in the UCI to report the channel information per slot. In addition, the UCI field in which the channel information per slot is transmitted may be a newly added field. However, the UCI fields below are merely examples, and the disclosure is not limited to these examples. Also, the examples of the UCI fields below are not necessarily limited to the examples related to FIG. 14, but may be related to other drawings of the disclosure.

In relation to FIG. 14, the fields for reporting the channel state indicators for each slot existing in the UCI may include Average_interference, Differential_Average_interference, Variance_interference, Std_interference, Average_SINR_Demodulation, Differential_Average_SINR_Demodulation, Variance_SINR_Demodulation, or Std_SINR_Demodulation.

Also, in relation to FIG. 14, the UCI may include information that can be used to perform the group-based OLRC as well as a field to be used for reporting the channel information per slot. In the disclosure, performing the group-based OLRC refers to determining the MCS for each group based on the SINR that has undergone a sufficient correction process based on the group-based OLRC. Also, determining an appropriate MCS for each group or performing an appropriate OLRC refers to estimating the channel state for each group and, based on this, determining an appropriate MCS level.

For example, the base station may predefine slot group information for performing the appropriate group-based OLRC or share it with the UE through RRC configuration. In this case, the UCI field may include an index value that the UE determines to be the optimal group.

Specifically, in relation to the above example, information related to candidates of a group that is predefined or shared with the UE through RRC configuration may be information based on Equation 10 below.

[Equation 10]
<Proposed RRC Configuration or Predefined>

| GroupedOLRCBookList :: = { | |
|---|---|
| Index 0 : methodId 1 | |
| Index 1 : methodId 2 | |
| . | . |
| . | . |
| . | . |
| } | |
| methodID : | |
| { | |
| GroupeddOLRC_methodId = 1 | |
| OLRC_Grouping={{{D#1,D#2},{D#3,D#4}} | |
| OLRC_Parameter={{0.05,0.25},{0.05,0.25}} | |
| %{AckStepSize,NackStepSize} | |
| GroupeddOLRC_methodId = 2 | |
| OLRC_Grouping={{{D#1},{D#2,D#3,D#4}} | |
| OLRC_Parameter={{0.10,0.25},{0.05,0.50}} | |
| %{AckStepSize,NackStepSize} | |
| . | . |
| . | . |
| . | . |

}

Specifically, an index value that the UE determines to be the optimal group may be included in the UCI, and the index value may be based on Equation 11 below.

$$Best Advanced OLRC Idx , e . g . , 0 \qquad [ Equation 11 ]$$

Further, in relation to FIG. 14, if the base station has a limitation on configuring slot groups for performing the group-based OLRC, and the UE shares the limitation through RRC, a field may be included in the UCI to determine the degree of group separation suitability by dividing it into X levels and reporting one of them.

Specifically, for example, if there is a limitation on the slot group configuration that only the following two schemes are available: 1) D #1 and D #2 are grouped into one group, and D #3 and D #4 are grouped into another group, and 2) D #1 is grouped into one group, and D #2, D #3, and D #4 are grouped into another group, then the RRC configuration may be based on Equation 12 below.

[Equation 12]
<Proposed RRC Configuration> (Example when there are two schemes)

```
GroupedOLRCList ::={
{
  GroupeddOLRC_methodId = 1
    OLRC_Grouping={{{D#1,D#2},{D#3,D#4}}
      OLRC_Parameter={{0.05,0.25},{0.05,0.25}}
    %{AckStepSize,NackStepSize}
}
{
  GroupeddOLRC_methodId = 2
    OLRC_Grouping={{{D#2},{D#1,D#3,D#4}}
      OLRC_Parameter={{0.10,0.50},{0.05,0.50}}
    %{AckStepSize,NackStepSize}
}}
```

In this case, one index value may be included in the UCI during the step a of determining suitability for a case where the UE performs the group-based OLRC based on the schemes 1) and 2), and the index value may be based on Equation 13 below.

$$Preferred Level of Advanced OLRC , e . g . , 101 , 111 ( if α = 8 ) \qquad [ Equation 13 ]$$

Meanwhile, in relation to the generation of slot groups for the group-based OLRC, there may be restrictions on the slot group information that can be generated.

If there is no restriction on the slot group that can be generated, the slot group information that is not restricted may be predefined or transmitted to the UE via RRC. The unrestricted slot group information may include a plurality of indexes and group candidates corresponding to the indexes, and the group candidates may include slots included in the group candidates, OLRC parameter values for performing the group-based OLRC, or the like. At this time, the number of indexes of the unrestricted slot group information may be ₄C₁+₄C₂+₄C₃ (where ₙCᵣ denotes a combination operation) in the TDD 4:1 communication system. This is because, since there is no restriction on the slot group that can be generated, one slot can form one slot group, two slots can form one slot group, and three slots can form one slot group.

The unrestricted slot group information may be information related to Equation 10. For example, the unrestricted slot group information may include a total of 14 Method IDs, and may include slots included in the group candidates corresponding to the Method IDs, OLRC parameter values for performing OLRC for each group, or the like.

If there is a restriction on the slot group that can be generated, the restricted slot group information may be transmitted to the UE via RRC. The restricted slot group information may include a Method ID of the restricted slot group, a group corresponding to the Method ID, or an OLRC parameter corresponding to the Method ID.

The restricted slot group information may be information related to Equation 12. For example, the restricted slot group information may include Method ID 1 and Method ID 2. The restricted slot group information may include slot group information corresponding to Method ID 1 and Method ID 2 (i.e., information indicating that Method ID 1 is that D #1 and D #2 are one group and D #3 and D #4 are another group, and Method ID 2 is that D #2 is one group and D #1, D #3, D #4 are another group). In addition, the restricted slot group information may include an OLRC parameter corresponding to Method ID 1 or an OLRC parameter corresponding to Method ID 2.

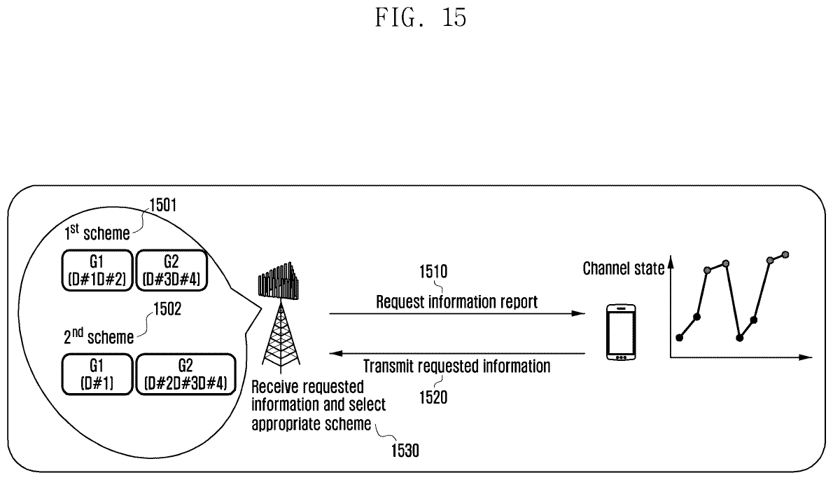

FIG. 15 illustrates a diagram of a method for a UE to transmit requested information to a base station based on a report request from the base station in a wireless communication system according to an embodiment of the present disclosure.

The following description regarding FIG. 15 is not limited to the case based on a report request from the base station, and may also be applied to the case where there is no report request from the base station.

The requested information reported by the UE to the base station may be information related to selecting an appropriate scheme, and the information related to selecting an appropriate scheme may include channel information per slot. Based on the channel information per slot received from the UE, the base station may classify slots into appropriate groups. That is, using the received channel information per slot, the base station may separate the slots into appropriate groups for OLRC. By separating the slots into appropriate groups for OLRC, the base station may separately perform link adaptation operation for each slot group. In this case, separately performing the link adaptation operation for each slot group refers to performing the OLRC for each group and thereby determining an appropriate MCS value for each group.

Meanwhile, before measuring channel information of each slot, the UE may receive from the base station a reference signal to be used for measuring the channel information of each slot, including DMRS related to PDSCH reception. Whenever receiving downlink data, the UE may measure the channel information of each slot based on the reference signal. The channel information of each slot measured by the UE may be the amount of interference or SINR-based information, and the amount of interference may be calculated based on the SINR value of each slot measured by the UE.

In step 1510, the base station may request information related to selecting which of the first scheme 1501 or the second scheme 1502 is appropriate from the UE. The first scheme 1501 may be a scheme of setting D #1 and D #2 to one group and setting D #3 and D #4 to another group, and the second scheme 1502 may be a scheme of setting D #1 to one group and setting D #2, D #3 and D #4 to another group.

Also, in step 1510, the base station may request an information report from the UE based on the first and second schemes, and the requested information may be information related to selection of an appropriate scheme. The information related to selection of an appropriate scheme may include channel information per slot. In this case, the requested channel information per slot may not be necessarily the channel information per slot regarding all slots, but may be the channel information per slot regarding at least one or more slots. For example, the base station may request only average channel state information of slot D #2 from the UE.

In step 1520, the UE may transmit the requested information to the base station based on the channel information for each slot measured by the UE.

In step 1530, the base station that receives the requested information from the UE may select an appropriate scheme including the first or second scheme based on the received information.

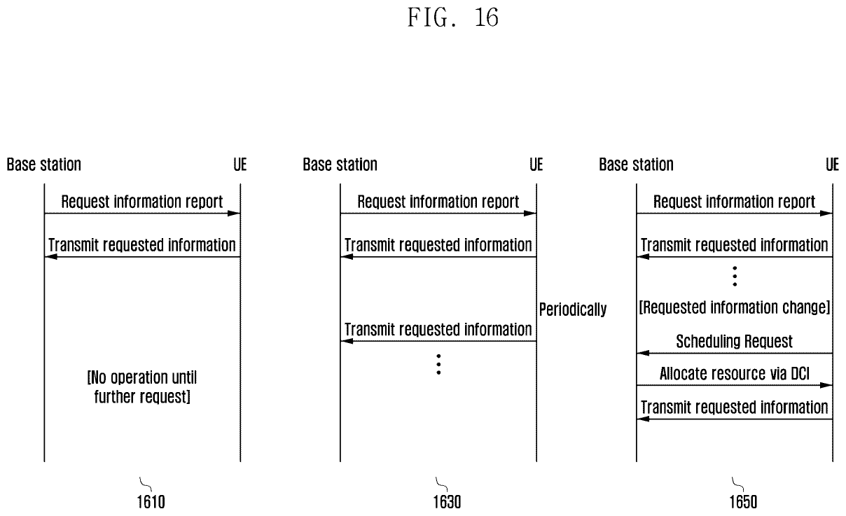

FIG. 16 illustrates a diagram of a method for a UE to report requested information to a base station periodically or aperiodically based on a report request from the base station in a wireless communication system according to an embodiment of the present disclosure.

The following description regarding FIG. 16 is not limited to the case based on a report request from the base station, and may also be applied to the case where there is no report request from the base station.

In relation to FIG. 16, the requested information may be information related to selecting an appropriate scheme, and the information related to selecting an appropriate scheme may include channel information per slot. Meanwhile, the UE may report the requested information periodically or aperiodically in response to the base station's information report request.

Reference numerals 1610 and 1650 show cases where the UE aperiodically transmits the requested information to the base station in response to the base station's information report request, and reference numeral 1630 shows a case where the UE periodically transmits the requested information to the base station in response to the base station's information report request.

In the case 1610, the base station requests information reporting from the UE based on DCI or RRC, and the UE transmits the requested information once in response to the request of the base station. In the case 1610, if the base station does not further request information reporting, the UE does not transmit the requested information again.

In the case 1610, the requested information may be transmitted based on a field added to the UCI, and the UCI may be transmitted via PUSCH or PUCCH.

Meanwhile, in the disclosure, the DCI includes a field indicating an index value of a slot to be reported, or a field indicating channel information to be reported in a slot corresponding to the slot index value. In the TDD 4:1 communication system, the slot index value to be reported may be at least one of 1, 2, 3, or 4, and the channel information to be reported in a slot corresponding to the slot index may include at least one of an average interference of a plurality of slots having the same value, an average relative interference difference (or differential average interference), a variance interference, an interference standard deviation (or std interference), an average SINR estimated based on DMRS (or average SINR demodulation), an average relative SINR difference estimated based on DMRS (or differential average SINR demodulation), a variance of SINR values estimated based on DMRS (or variance SINR demodulation), or a standard deviation of SINR values estimated based on DMRS (or std SINR demodulation).

In the case 1630, the base station requests information reporting from the UE based on DCI or RRC, and the UE periodically transmits the requested information in response to the request of the base station. Unlike the case 1610, in the case 1630, even if the base station does not continuously request information reporting, the UE periodically transmits the requested information.

In the case 1630, the requested information may be transmitted based on a field added to the UCI, and the UCI may be transmitted via PUSCH or PUCCH.

In the case 1650, the base station requests information reporting from the UE based on DCI or RRC, and the UE transmits the requested information once in response to the request of the base station. In the case 1650, unlike the case 1610, if there is a change greater than a threshold in the requested information, the UE transmits an SR to the base station, receives resource allocation from the base station through DCI, and transmits the requested information based on the allocated resource.

The case 1650 is distinguished from the case 1610 in that the SR is transmitted when there is a change greater than a threshold in the requested information, and it is distinguished from the case 1630 in that the requested information is aperiodically transmitted.

In the case 1650, the requested information may be transmitted based on a field added to the UCI, and the UCI may be transmitted via PUSCH or PUCCH.

In relation to FIG. 16, the following fields may exist in the UCI to report the requested information. In addition, the UCI field in which the requested information is transmitted may be a newly added field. However, the UCI fields below are merely examples, and the disclosure is not limited to these examples. Also, the examples of the UCI fields below are not necessarily limited to the examples related to FIG. 14, but may be related to other drawings of the disclosure.

The base station may share with the UE the information related to candidates of a group for performing the appropriate group-based OLRC through RRC configuration. For example, this information may be based on Equation 14 below. In the disclosure, performing the group-based OLRC refers to determining the MCS for each group based on the SINR that has undergone a sufficient correction process based on the group-based OLRC. Also, determining an appropriate MCS for each group or performing an appropriate OLRC refers to estimating the channel state for each group and, based on this, determining an appropriate MCS level.

[Equation 14]
<Example of RRC configuration information>
(Example when there are two schemes)

```
GroupedOLRCList ::={
{
  GroupeddOLRC_methodId = 1
    OLRC_Grouping={{{D1,D2},{D3,D4}}
    OLRC_Parameter={{0.05,0.25},{0.05,0.25}}
    %{AckStepSize,NackStepSize}
}
{
  GroupeddOLRC_methodId = 2
    OLRC_Grouping={{{D1},{D1,D3,D4}}
    OLRC_Parameter={{0.05,0.25},{0.05,0.25}}
    %{AckStepSize,NackStepSize}
}}
```

In relation to the above example, request information that the base station transmits to the UE may be the following a, b, and c.

a. A field for requesting a channel state indicator for a specific slot or all slots

b. A field for requesting a channel state for a specific slot group

c. A field for requesting a step-by-step evaluation of the suitability of separate link adaptation operation for each slot group that the UE wants to perform

In order to transmit the request information a, b, and c, the following fields may exist in the DCI. The following DCI fields may be newly defined and added fields for transmitting the request information

<Proposed DCI Fields>

```
  a. A field for requesting a channel state indicator for a specific slot or all slots
  - Required Field for Grouped OLRC : 00
  - Required information for Grouped OLRC, 2bit
    e.g., 01 (Interference (or SINR)), 10 (Variance (or Standard deviation)), 11 ((Interference
(or SINR)), Variance (or Standard deviation))
  - Required slotidx for Grouped OLRC 4bit
    e.g., 0011
    (It is also possible to configure a specific slot index set with RRC and then use it as an
index)
  b. A field for requesting a channel state for a specific slot group
  - Required Field for Grouped OLRC : 01
  - Required information for Grouped OLRC, 2bit
    e.g., 01 (Interference (or SINR)), 10 (Variance (or Standard deviation)), 11 ((Interference
(or SINR)), Variance (or Standard deviation))
  - Required Groupidx for Grouped OLRC, 4bit
    e.g., 1100 (G={D#1,D#2})
    (It is also possible to configure a specific slot index set with RRC and then use it as an
index)
  c. A field for requesting evaluation, divided into β stages, of the suitability of separate
link adaptation operation for each slot group that the UE wants to perform
  - Required Field for Grouped OLRC : 10
  - Evaluated Grouped OLRC method, nbit :
    e.g., 01 (evaluation request for 0th scheme), 10 (evaluation request for 1st scheme), 11
(evaluation request for 0th and 1st schemes)
```

In relation to the above example, the following fields may exist in the UCI for a response based on the base station's request information. The following DCI fields may be newly defined and added fields for transmitting the request information.

<Proposed UCI Fields>

```
  a. A field for reporting a channel state indicator for a specific slot or all slots
  - Required channel information for Grouped OLRC, n_{d} bit
  (e.g., In case of receiving, via DCI, Required information for Grouped OLRC : 11,
Required slotidx for Grouped OLRC : 1100
  - Required channel information for Grouped OLRC = Average interference of D#1 n_{d11}
bit + Interference variance information of D#1 n_{d12} bit + Average interference of D#2 n_{d21} bit +
Interference variance information of D#2 n_{d22} bit)
  b. A field for reporting a channel state for a specific slot group
  - Required channel information for Grouped OLRC, n_{g} bit
  (e.g., In case of receiving, via DCI, Required information for Grouped OLRC : 11,
Required Groupidx for Grouped OLRC : 1100 (G#1={D1,D2})
  - Required channel information for Grouped OLRC = Average interference of slot included
in G#1 n_{g11} bit + Average information of interference variance of slot included in G#1 n_{g12} bit)
  c. A field for judging the suitability of separate link adaptation operation for each slot group
that the UE wants to perform by dividing it into β stages and reporting one of them
  - Required channel information for Advanced OLRC, nₑ bit
  (e.g., In case of receiving, via DCI, Evaluated Advanced OLRC method for Advanced
OLRC : 11
  - Required channel information for Advanced OLRC, e.g., 101, 111 (if β=8)
```

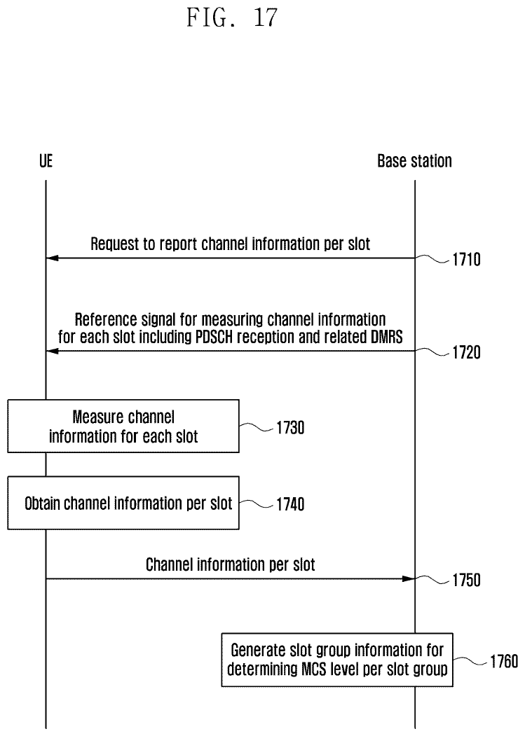

FIG. 17 illustrates a flowchart of operations in which a UE obtains channel information per slot and transmits it to a base station in a wireless communication system according to an embodiment of the present disclosure.

The steps of FIG. 17 may be distinguished for convenience of explanation, and some steps related to FIG. 17 may be omitted or added. In addition, the disclosure is not limited to such steps. In the disclosure, the channel information per slot may have the same meaning as slot-related channel information, and they may be used interchangeably.

In step 1710, the UE may be requested to report the channel information per slot from the base station. As mentioned above, step 1710 may be omitted, so that the UE may report the channel information per slot based on a report request from the base station, and even if there is no report request from the base station, the UE may report the channel information per slot to the base station.

In step 1720, the UE may receive from the base station a reference signal to be used for measuring the channel information for each slot. The reference signal received by the UE from the base station may include DMRS, and the DMRS may be a reference signal related to PDSCH reception.

In step 1730, the UE may measure the channel information for each slot. The channel information for each slot may be measured based on the reference signal received in step 1720.

In relation to step 1730, the channel information of each slot may be SINR-related information, and may be information that is continuously observed whenever the UE receives downlink data. The UE may update the channel information of each slot whenever it receives downlink data.

In step 1740, the UE may obtain the channel information per slot. The UE may obtain the channel information per slot based on the channel information for each slot. For example, using the SINR or interference amount for each slot, the UE may obtain at least one of an average interference of a plurality of slots having the same value, an average relative interference difference (or differential average interference), a variance interference, an interference standard deviation (or std interference), an average SINR estimated based on DMRS (or average SINR demodulation), an average relative SINR difference estimated based on DMRS (or differential average SINR demodulation), a variance of SINR values estimated based on DMRS (or variance SINR demodulation), or a standard deviation of SINR values estimated based on DMRS (or std SINR demodulation). Specifically, the UE may obtain the SINR values and interference amount of the downlink-configured slots that appear Nth after the uplink-configured slot, and store them in the channel information of the Nth slot. In the 4:1 TDD communication system, ‘N’ may be one of 1, 2, 3, and 4.

In relation to step 1740, the interference amount may be calculated based on the SINR value of each slot measured by the UE. For a description and a calculation method of the interference amount, refer to the description of FIG. 12.

In relation to step 1740, the channel information per slot may be information for each slot index determined based on the modulation operation, and the information for each slot index may include at least one or more of average, variance, and standard deviation of the interference amounts of multiple slots having the same slot index. In addition, the information for each slot index may include at least one or more of average, variance, and standard deviation of the SINR values of multiple slots having the same slot index.

Meanwhile, in relation to step 1740, the channel information per slot may be updated whenever the UE receives downlink data.

In step 1750, the UE may transmit the channel information per slot to the base station. The channel information per slot may be information obtained in step 1740.

In relation to step 1750, the UE may transmit the channel information per slot based on a request from the base station, and even if there is no base station's request, the UE may transmit the channel information per slot.

In relation to step 1750, the UE may transmit the channel information per slot periodically or aperiodically. In this case, aperiodically transmitting may include transmitting once, or additionally transmitting when the channel information per slot or base station request information changes over a threshold value after one transmission.

In step 1760, the base station may generate slot group information for determining an MCS level for each slot group based on the received channel information per slot.

After step 1760, the base station may transmit the slot group information to the UE for determining the MCS level per slot group, and the UE may transmit a CSI report for each group to the base station based on the received slot group information. The base station may determine an appropriate MCS level per group based on the CSI report per group and UE's HARQ ACK/NACK information per group. Step 1760 and the subsequent step are described to demonstrate the effect or utility according to the disclosure, and the disclosure may not include steps after step 1760.

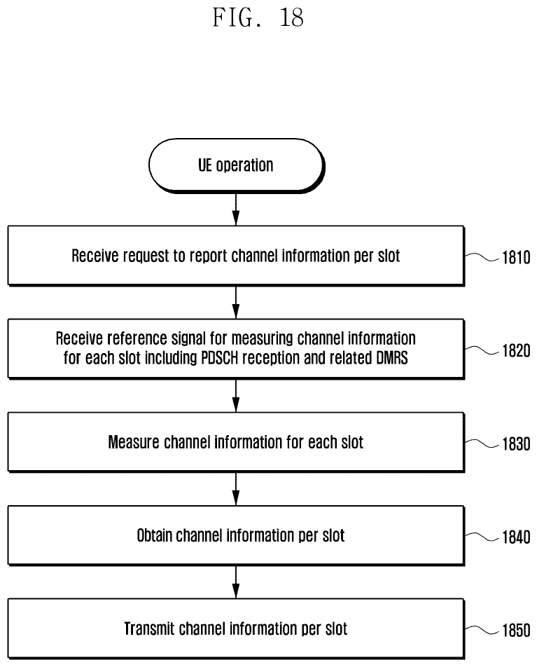

FIG. 18 illustrates a flowchart of a UE's operations related to acquisition and transmission/reception of channel information per slot in a wireless communication system according to an embodiment of the present disclosure.

The steps of FIG. 18 may be distinguished for convenience of explanation, and some steps related to FIG. 18 may be omitted or added. In addition, the disclosure is not limited to such steps. In the disclosure, the channel information per slot may have the same meaning as slot-related channel information, and they may be used interchangeably.

In step 1810, the UE may be requested to report the channel information per slot from the base station. As mentioned above, step 1810 may be omitted, so that the UE may report the channel information per slot based on a report request from the base station, and even if there is no report request from the base station, the UE may report the channel information per slot to the base station.

In step 1820, the UE may receive from the base station a reference signal to be used for measuring the channel information for each slot. The reference signal received by the UE from the base station may include DMRS, and the DMRS may be a reference signal related to PDSCH reception.

In step 1830, the UE may measure the channel information for each slot. The channel information for each slot may be measured based on the reference signal received in step 1820.

In relation to step 1830, the channel information of each slot may be SINR-related information, and may be information that is continuously observed whenever the UE receives downlink data. The UE may update the channel information of each slot whenever it receives downlink data.

In step 1840, the UE may obtain the channel information per slot. The UE may obtain the channel information per slot based on the channel information for each slot. For example, using the SINR or interference amount for each slot, the UE may obtain at least one of an average interference of a plurality of slots having the same value, an average relative interference difference (or differential average interference), a variance interference, an interference standard deviation (or std interference), an average SINR estimated based on DMRS (or average SINR demodulation), an average relative SINR difference estimated based on DMRS (or differential average SINR demodulation), a variance of SINR values estimated based on DMRS (or variance SINR demodulation), or a standard deviation of SINR values estimated based on DMRS (or std SINR demodulation). Specifically, the UE may obtain the SINR values and interference amount of the downlink-configured slots that appear Nth after the uplink-configured slot, and store them in the channel information of the Nth slot. In the 4:1 TDD communication system, ‘N’ may be one of 1, 2, 3, and 4.

In relation to step 1840, the interference amount may be calculated based on the SINR value of each slot measured by the UE. For a description and a calculation method of the interference amount, refer to the description of FIG. 12.

In relation to step 1840, the channel information per slot may be information for each slot index determined based on the modulation operation, and the information for each slot index may include at least one or more of average, variance, and standard deviation of the interference amounts of multiple slots having the same slot index. In addition, the information for each slot index may include at least one or more of average, variance, and standard deviation of the SINR values of multiple slots having the same slot index.

Meanwhile, in relation to step 1840, the channel information per slot may be updated whenever the UE receives downlink data.

In step 1850, the UE may transmit the channel information per slot to the base station. The channel information per slot may be information obtained in step 1840.

In relation to step 1850, the UE may transmit the channel information per slot based on a request from the base station, and even if there is no base station's request, the UE may transmit the channel information per slot.

In relation to step 1850, the UE may transmit the channel information per slot periodically or aperiodically. In this case, aperiodically transmitting may include transmitting once, or additionally transmitting when the channel information per slot or base station request information changes over a threshold value after one transmission.

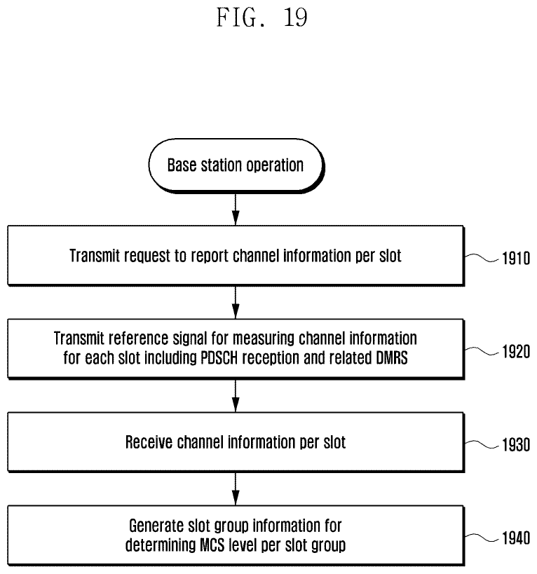

FIG. 19 illustrates a flowchart of a base station's operations related to acquisition and transmission/reception of channel information per slot in a wireless communication system according to an embodiment of the present disclosure.

The steps of FIG. 19 may be distinguished for convenience of explanation, and some steps related to FIG. 19 may be omitted or added. In addition, the disclosure is not limited to such steps. In the disclosure, the channel information per slot may have the same meaning as slot-related channel information, and they may be used interchangeably.

In step 1910, the base station may request the UE to report channel information per slot. As mentioned above, step 1910 may be omitted.

In step 1920, the base station may transmit to the UE a reference signal to be used for measuring channel information for each slot. The reference signal transmitted by the base station to the UE may include DMRS, and the DMRS may be a reference signal related to PDSCH.

In step 1930, the base station may receive the channel information per slot from the UE.

In relation to step 1930, with respect to the channel information per slot received by the base station from the UE, the base station may or may not have requested information reporting in step 1910.

In relation to step 1930, the base station may receive the channel information per slot from the UE periodically or aperiodically. In this case, aperiodically receiving may include receiving once, or additionally receiving when a specific situation occurs after receiving once.

In step 1940, based on the received channel information per slot, the base station may generate slot group information for determining an MCS level per slot group.

After step 1940, the base station may transmit the slot group information to the UE for determining the MCS level per slot group. In addition, the base station may determine an appropriate MCS level per group based on a CSI report per group and UE's HARQ ACK/NACK information per group. Step 1940 and the subsequent step are described to demonstrate the effect or utility according to the disclosure, and the disclosure may not include step 1940 or steps after step 1940.

Meanwhile, with reference to FIG. 17 again, in step 1760, the base station may generate slot group information for determining an MCS level, based on the channel information per slot received from the UE. Thereafter, the base station may transmit the generated slot group information to the UE. The UE may transmit, to the base station, channel state information (CSI) for each slot group divided based on the slot group information received from the base station. For example, the UE may transmit a CSI report including the CSI for each slot group to the base station. The base station may determine an MCS level for each slot group, based on the CSI and HARQ ACK/NACK information for each slot group.

With reference to FIG. 7 again, the average channel states of slots may be different from each other. In other words, in the example of FIG. 7, the average channel states of D #1 to D #4 are different from each other, so that a method of grouping multiple slots by a common criterion is not suitable. Therefore, the MCS level of each of D #1 to D #4 may have to be determined through OLRC for each slot. When the channel states of slots are different from each other as in FIG. 7, the base station may generate the slot group information based on the process described above so that each slot is included in a different group.

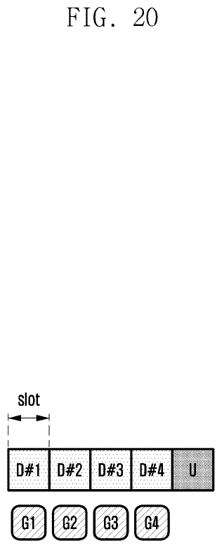

FIG. 20 illustrates a diagram of slot groups generated according to an embodiment of the present disclosure. Specifically, FIG. 20 shows slot groups generated so that each slot is included in a different group because the channel states of slots are different from each other.

With reference to FIG. 20, if the average channel states of slots are different from each other and thus a method of grouping multiple slots by a common criterion is not suitable, the base station may generate slot groups so that each slot is included in a different group. For example, D #1 may be configured as slot group 1 (G1), D #2 as slot group 2 (G2), D #3 as slot group 3 (G3), and D #4 as slot group 4 (G4).

When the slot groups are generated as in the example of FIG. 20, the base station may determine for each slot an MCS suitable for the channel state per slot. However, when the size of the slot group becomes excessively small, the HARQ ACK/NACK feedback sample may be significantly reduced, which may deteriorate the efficiency of MCS level adjustment. Specifically, the HARQ ACK/NACK feedback may be limited to 1 bit per slot, and thus, information collected by the base station for each slot may be insufficient. In this case, it may take a long time for the base station to determine an appropriate MCS for the channel state per slot, or the base station may determine an inaccurate MCS for the channel state per slot. For example, if the base station performs OLRC on a slot basis in a situation of receiving NACKs for all slots due to a sudden degradation of channel quality at the UE, the base station may not be able to quickly perform SINR prediction for a slot with a small NackStepSize. Specifically, in case of receiving NACK as a response from the UE for all slots (D #1, D #2, D #3, and D #4), the base station may determine the SINR for each slot based on Equation 15 below.

$$\begin{matrix}{SINR}_{Final ( s )} = SINR ( s ) + SlotLevelOLRCoffset ( s ) \\ SlotLevelOLRCoffset ( 1 ) = SlotLevelOLRCoffset ( 1 ) - Nackstepsize \\ SlotLevelOLRCoffset ( 2 ) = SlotLevelOLRCoffset ( 2 ) - Nackstepsize \\ SlotLevelOLRCoffset ( 3 ) = SlotLevelOLRCoffset ( 3 ) - Nackstepsize \\ SlotLevelOLRCoffset ( 4 ) = SlotLevelOLRCoffset ( 4 ) - Nackstepsize\end{matrix} \qquad [ Equation 15 ]$$

With reference to Equation 15, when the base station performs OLRC on a slot basis, NackStepSize may be configured differently for each slot, and thus the base station may not be able to quickly perform SINR prediction for a slot with a small NackStepSize.

In other words, when the base station performs OLRC on a slot basis, the SINR prediction adjustment speed of the base station may be slow in a rapid channel change situation. Additionally, in an intermittent traffic situation or an environment where a large number of terminals are connected, signal or information transmission may not occur for a long period of time in a specific slot, which may lead to a lack of HARQ ACK/NACK feedback, and thus delay in OLRC offset update.

Unlike the example of FIG. 20, in order to increase the number of HARQ ACK/NACK feedback samples, the base station may generate a slot group so that respective slots have the same group.

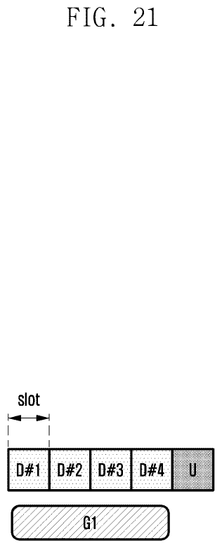

FIG. 21 illustrates a diagram of a slot group generated according to an embodiment of the present disclosure. Specifically, FIG. 21 shows a slot group generated so that all slots are included in the same group in order to increase the number of HARQ ACK/NACK feedback samples.

With reference to FIG. 21, in order to increase the number of HARQ ACK/NACK feedback samples for slots, the base station may generate a slot group so that all slots are included in the same group. For example, D #1 to D #4 may be configured as slot group 1 (G1).

When the slot group is generated as in the example of FIG. 21, the number of HARQ ACK/NACK feedback samples increases, so that the base station may efficiently adapt to rapid channel change situations through OLRC. For example, in case of receiving NACK as a response from the UE for all slots (D #1, D #2, D #3, and D #4), the base station may determine the SINR for each slot based on Equation 16 below.

$$\begin{matrix}SINR\_Final = SINR + MainOLRCoffset \\ MainOLRCoffset = MainOLRCoffset - 4 * Nackstepsize\end{matrix} \qquad [ Equation 16 ]$$

With reference to Equation 16, when all slots are included in the same group and the base station performs OLRC on a slot group basis, the base station may adapt to the current channel state more quickly by lowering the predicted SINR (or lowering the MCS) in all slots by 4*Nackstepsize as in Equation 16.

As a result, when the number of slots included in a slot group decreases, the base station may perform a precise MCS determination suitable for the channel state of a specific slot. However, when the size of a slot group decreases, the number of HARQ ACK/NACK feedback samples is likely to decrease, which may slow down the channel state adaptation speed of the base station and may cause a delay in OLRC offset update. In contrast, when the number of slots included in a slot group increases, the base station may perform a MCS determination more efficiently for a rapidly changing channel state. However, when the size of a slot group increases, it may become difficult to perform a precise MCS determination suitable for the channel state of an individual slot.

In order to combine the advantages and overcome the disadvantages of the case where the size of the slot group is small and the case where the size of the slot group is large, the disclosure proposes a multi-layer OLRC operating method. In the disclosure, the multi-layer OLRC operating method is defined as a scheme that the base station generates slot groups in multiple layers or a plurality layers. Here, the meaning of “generating slot groups in in multiple layers or a plurality layers” is that slot groups are independently formed for each layer and the base station determines SINR or MCS for each slot based on the slot groups formed for each layer. In each layer, each slot may be included in at least one group. The SINR or MCS for a specific slot may be determined based on the sum of parameters determined for each of at least one group to which the specific slot belongs.

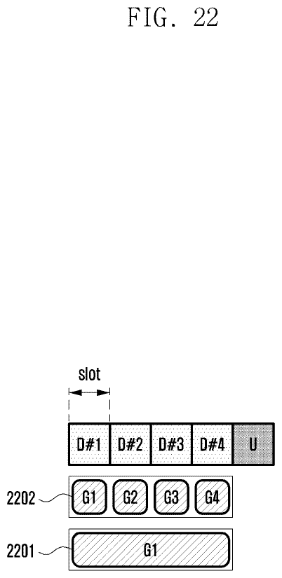

FIG. 22 illustrates a diagram of slot groups generated in multiple layers according to an embodiment of the present disclosure.

With reference to FIG. 22, slots may be grouped into slot groups of two layers 2201 and 2202. Specifically, in the first layer 2201, slots D #1 to D #4 may be included in the first slot group G1, and in the second layer 2202, slots D #1 to D #4 may be included in the first slot group G1 to the fourth slot group G4, respectively. Note that the first slot group G1 of the first layer 2201 and the first slot group G1 of the second layer 2202 may be different groups. As in the example of FIG. 22, when slot groups are formed in two layers, the base station may predict the SINR for each slot by summing up the SINRs calculated based on the slot groups of each layer. For example, if the base station receives NACK, ACK, ACK, and ACK in slot U as responses to downlink signals transmitted in slots D #1, D #2, D #3, and D #4 from a certain UE, respectively, the base station may predict the SINR for each slot based on Equation 17 below.

$$\begin{matrix}SINR\_Final ( s ) = SINR ( s ) + α * MainOLRCOffset + β * SlotLevelOLRCoffset ( s ) \\ MainOLRCoffset = MainOLRCoffset + 3 * Ackstepsize - Nackstepsize \\ SlotLevelOLRCoffset ( 1 ) = SlotLevelOLRCoffset ( 1 ) - Nackstepsize \\ SlotLevelOLRCoffset ( 2 ) = SlotLevelOLRCoffset ( 2 ) + Ackstepsize \\ SlotLevelOLRCoffset ( 3 ) = SlotLevelOLRCoffset ( 3 ) + Ackstepsize \\ SlotLevelOLRCoffset ( 4 ) = SlotLevelOLRCoffset ( 4 ) + Ackstepsize\end{matrix} \qquad [ Equation 17 ]$$

With reference to Equation 17, when the base station receives NACK, ACK, ACK, and ACK in slot U as responses to downlink signals transmitted in slots D #1, D #2, D #3, and D #4 from the UE, respectively, the base station may predict the SINR for D #1 as the sum of corrected MainOLRCOffset for the first layer 2201 and corrected SlotLevelOLRCoffset(1) for the second layer 2202. Similarly, the base station may predict the SINR for D #2 as the sum of corrected MainOLRCOffset for the first layer 2201 and corrected SlotLevelOLRCoffset(2) for the second layer 2202. Similarly, the base station may predict the SINR for D #3 as the sum of corrected MainOLRCOffset for the first layer 2201 and corrected SlotLevelOLRCoffset(3) for the second layer 2202. Similarly, the base station may predict the SINR for D #4 as the sum of corrected MainOLRCOffset for the first layer 2201 and corrected SlotLevelOLRCoffset(4) for the second layer 2202.

In another example, if the channel state of a certain UE deteriorates and the base station receives NACK, NACK, NACK, and NACK in slot U as responses to downlink signals transmitted from the UE in slots D #1, D #2, D #3, and D #4, respectively, the base station may predict the SINR for each slot based on Equation 18 below.

$$\begin{matrix}SINR\_Final ( s ) = SINR ( s ) + α * MainOLRCOffset + β * SlotLevelOLRCoffset ( s ) \\ MainOLRCoffset = MainOLRCoffset - 4 * Nackstepsize \\ SlotLevelOLRCoffset ( 1 ) = SlotLevelOLRCoffset ( 1 ) - Nackstepsize \\ SlotLevelOLRCoffset ( 2 ) = SlotLevelOLRCoffset ( 2 ) - Nackstepsize \\ SlotLevelOLRCoffset ( 3 ) = SlotLevelOLRCoffset ( 3 ) - Nackstepsize \\ SlotLevelOLRCoffset ( 4 ) = SlotLevelOLRCoffset ( 4 ) - Nackstepsize\end{matrix} \qquad [ Equation 18 ]$$

With reference to Equations 17 and 18, when two-layer slot groups are formed, the base station may make a precise MCS determination suitable for the channel state of an individual slot, and at the same time, perform the MCS determination more efficiently for a rapidly changing channel state.

In some embodiments, the base station may predict the SINR for D #n based on a weighted sum of corrected MainOLRCOffset for the first layer 2201 and corrected SlotLevelOLRCoffset(n) for the second layer 2202. Here, the weight of each of MainOLRCOffset and SlotLevelOLRCoffset(n) may be determined based on the size of the slot group. For example, as the size of the slot group is smaller, the weight of the offset parameter for each slot group may be set to a larger value. For example, in Equation 17, the weight (a) of MainOLRCOffset, which is an offset parameter for the first group G1 of the first layer 2201, may be set to a smaller value than the weight (B) of SlotLevelOLRCoffset(n), which is an offset parameter for the nth group Gn of the second layer 2202. Conversely, as the size of the slot group is smaller, the weight of the offset parameter for each slot group may be set to a smaller value.

Meanwhile, according to an embodiment of the disclosure, the base station may allocate traffic to each slot based on the Heavy BO slot rule in order to improve the efficiency of large-scale traffic processing and interference management.

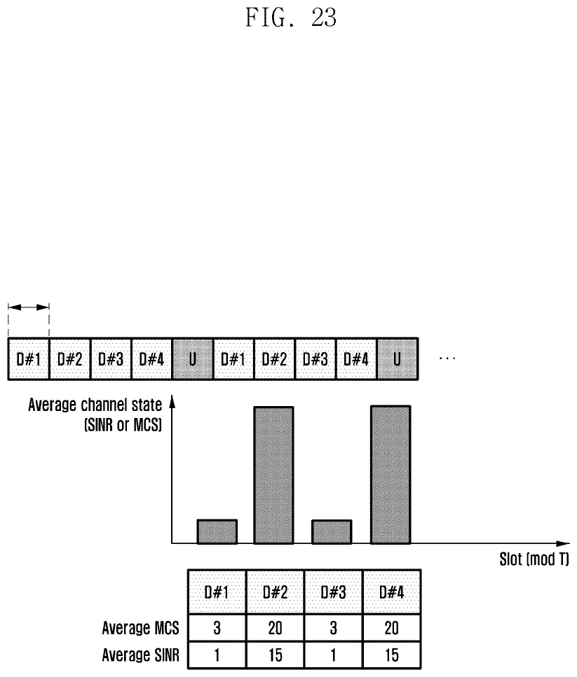

FIG. 23 illustrates a diagram of an average channel state per slot and an optimal MCS per slot when a base station configures a Heavy BO slot group in a wireless communication system according to an embodiment of the present disclosure. In FIG. 23, the horizontal axis of the graph represents a time domain distinguished by slot units, and the vertical axis represents an average channel state per slot.

According to an embodiment, the base station may include a Heavy BO slot group management device. The Heavy BO slot group management device may be configured to intensively allocate data exceeding a certain size (N bytes or more) among traffic within a cell to a specific slot. In this case, the specific slot may be referred to as a Heavy BO slot. Additionally, a slot that is not configured as the Heavy BO slot may be referred to as a non-Heavy BO slot. Cells managed by the Heavy BO slot group management device may intensively gather and allocate high-capacity traffic to the Heavy BO slot group.

With reference to FIGS. 23, D #1 and D #3 may be configured as the Heavy BO slots, and D #2 and D #4 may be configured as the non-Heavy BO slots. Therefore, in this case, high-capacity traffic may be allocated to D #1 and D #3. As a result, for example, the average MCS of D #1 and D #3 may be 3, and the average SINR may be 1. In addition, the average MCS of D #2 and D #4 may be 20, and the average SINR may be 15.

In a situation such as FIG. 23, when a difference occurs in channel environment between slots in the same group, the base station may determine an appropriate MCS for each slot by generating slot groups of two layers as described above.

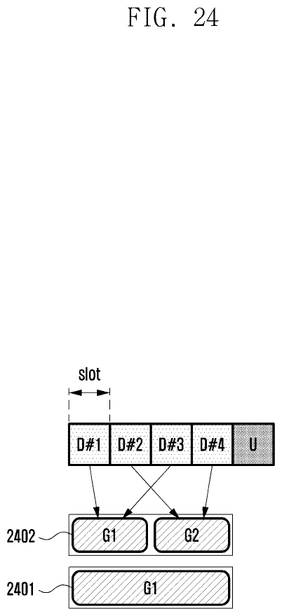

FIG. 24 illustrates a diagram of slot groups generated in multiple layers according to an embodiment of the present disclosure.

FIG. 24 is a diagram assuming that the base station allocates traffic to each slot based on the Heavy BO slot rule. For example, FIG. 24 is a diagram assuming that the base station configures D #1 and D #3 as Heavy BO slots and D #2 and D #4 as non-Heavy BO slots.

With reference to FIG. 24, in a situation like FIG. 23, slots may be grouped into slot groups of two layers 2401 and 2402. Specifically, in the first layer 2401, slots D #1 to D #4 may be included in the first slot group G1, while in the second layer 2402, D #1 and D #3 may be included in the first slot group G1, and D #2 and D #4 may be included in the second slot group G2. Note that the first slot group G1 of the first layer 2401 and the first slot group G1 of the second layer (2402) may be different groups.

According to the above discussion, for example, the SINR for each slot may be determined based on the sum of the offset parameter for the first group G1 of the first layer 2401 and the offset parameter for the nth group Gn of the second layer 2402.

In some embodiments, the base station may predict the SINR for each slot based on a weighted sum of the offset parameter for the nth group Gn of the first layer 2401 and the offset parameter for the nth group Gn of the second layer 2402. For example, the base station may predict the SINR or MCS of the UE based on the sum of the SINR value predicted from the CQI, of the product of the offset parameter for the nth group Gn of the first layer 2401 and the first weight α for the first layer 2401, and of the product of the offset parameter for the nth group Gn of the second layer 2402 and the second weight β for the second layer 2402. Here, the nth group Gn may refer to a group to which each slot belongs. Here, the weight of the offset parameter for each group may be determined based on the size of the slot group. For example, as the size of the slot group is smaller, the weight of the offset parameter for each slot group may be set to a larger value. Conversely, as the size of the slot group is smaller, the weight of the offset parameter for each slot group may be set to a smaller value.

As in the example of FIG. 24, when slot groups are formed in two layers, the base station may predict the SINR for each slot by summing up the SINRs calculated based on the slot groups of each layer. As in the example of FIG. 24, when two-layer slot groups are formed, the base station may make a precise MCS determination suitable for the channel state of each slot, and at the same time, perform the MCS determination more efficiently for a rapidly changing channel state.

Meanwhile, according to an embodiment of the disclosure, the base station may allocate traffic to each slot based on both the TDIA and the Heavy BO slot rule.

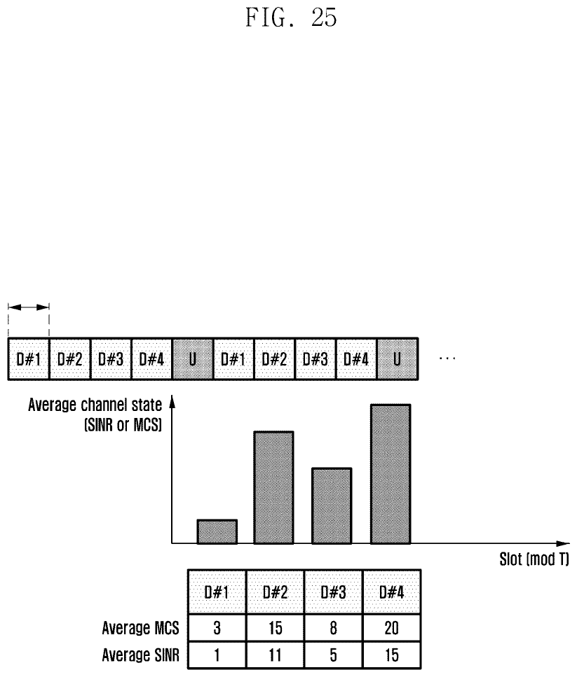

FIG. 25 illustrates a diagram of an average channel state per slot and an optimal MCS per slot when a base station configures a Heavy BO slot group and an aggregated slot based on TDIA in a wireless communication system according to an embodiment of the present disclosure.

With reference to FIG. 25, the base station may allocate traffic to each slot based on a plurality of interference control techniques (e.g., TDIA and Heavy BO slot rule). For example, D #1 may be configured as an aggregated slot. In addition, D #1 and D #3 may be configured as Heavy BO slots. Therefore, in this case, the average MCS of D #1 may be 3 and the average SINR may be 1, the average MCS of D #2 may be 15 and the average SINR may be 11, the average MCS of D #3 may be 8 and the average SINR may be 5, and the average MCS of D #4 may be 20 and the average SINR may be 15. In an example such as FIG. 25, slots may be grouped into slot groups of two layers. Specifically, in the first layer, slots D #1 to D #4 may be included in the first slot group, while in the second layer, slots D #1 and D #3 may be included in the first slot group, and slots D #2 and D #4 may be included in the second slot group.

However, in a situation like FIG. 25, even if the base station generates slot groups in two layers, the base station may not be able to properly compensate for the channel state difference between slot indexes within the same group (e.g., the channel state difference between D #1 and D #3 and between D #2 and D #4). In a situation like FIG. 25, in order to properly compensate for the channel state difference between D #1 and D #3 and between D #2 and D #4, the base station may need to group the slots so that each slot belongs to a different slot group, as in the example of FIG. 20. However, as described above, if the base station groups the slots so that each slot belongs to a different slot group as in the example of FIG. 20, the channel state adaptation speed of the base station may be reduced.

Considering the above problems, according to the disclosure, an OLRC operation method based on three layers can be proposed.

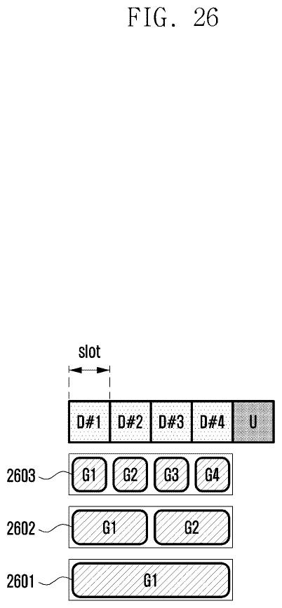

FIG. 26 illustrates a diagram of slot groups generated in multiple layers according to an embodiment of the present disclosure.

With reference to FIG. 26, slots may be grouped into slot groups of three layers 2601, 2602, and 2603. Specifically, in the first layer 2601, slots D #1 to D #4 may be included in the first slot group G1. In the second layer 2602, slots D #1 and D #3 may be included in the first slot group G1, and slots D #2 and D #4 may be included in the second slot group G2. In the third layer 2603, slots D #1 to D #4 may be included in the first slot group G1 to the fourth slot group G4, respectively. Note that the first slot group G1 of the first layer 2601, the first slot group G1 of the second layer 2602, and the first slot group G1 of the third layer 2603 may be different groups. As in the example of FIG. 26, when slot groups are formed in three layers, the base station may predict the SINR for each slot by summing up the SINRs calculated based on the slot groups of each layer.

According to the above discussion, for example, the SINR for each slot may be determined based on the sum of the offset parameter for the first group G1 of the first layer 2601, the offset parameter for the nth group Gn of the second layer 2602, and the offset parameter for the nth group Gn of the third layer 2603.

In some embodiments, the base station may predict the SINR for each slot based on a weighted sum of the offset parameter for the nth group Gn of the first layer 2401, the offset parameter for the nth group Gn of the second layer 2402, and the offset parameter for the nth group Gn of the third layer 2603. For example, the base station may predict the SINR or MCS of the UE based on the sum of the SINR value inferred from the CQI, the product of the offset parameter for the nth group Gn of the first layer 2601 and the first weight α for the first layer 2601, the product of the offset parameter for the nth group Gn of the second layer 2602 and the second weight β for the second layer 2602, and the product of the offset parameter for the nth group Gn of the third layer 2603 and the third weight γ for the third layer 2603. Here, the nth group Gn may refer to a group to which each slot belongs. Here, the weight of the offset parameter for each group may be determined based on the size of the slot group. For example, as the size of the slot group becomes smaller, the weight of the offset parameter for each slot group may be set to a larger value. Conversely, as the size of the slot group becomes smaller, the weight of the offset parameter for each slot group may be set to a smaller value.

In the case where slot groups are formed in three layers as in the example of FIG. 26, even if a plurality of interference control techniques are applied, the base station can make a precise MCS determination suitable for the channel state of each slot, and at the same time, perform the MCS determination more efficiently for a rapidly changing channel state.

In order to generate the above-discussed multi-layer slot groups, the base station may generate slot group information based on Equation 19 below. Specifically, the base station may construct slot-level scheduling (SLS) based on Equation 19 below.

[Equation 19]
<Main OLRC, Group-level OLRC and slot-level
OLRC implemented in SLS>

```
- Main OLRC offset update
  NackStepSize = 0.25 dB
  AckStepSize = NackStepSize * TargetBLER/(100 − TargetBLER)
  Target BLER = 10%
  if ACK; main_OLRC_Offset += AckStepSize
  if NACK; main_OLRC_Offset −= NackStepSize
- Group-level OLRC offset update
  NackStepSize[isHeavyBOSlots] = 0.25 dB
  AckStepSize[isHeavyBOSlots]
  = NackStepSize[isHeavyBOSlots] *
  TargetBLER[isHeavyBOSlots]/(100 − TargetBLER[isHeavyBOSlots])
  Target BLER[isHeavyBOSlots] = 10%
  if ACK; group-level_OLRC_Offset[isHeavyBOSlots] +=
  AckStepSize[isHeavyBOSlots]
  if NACK; group-level_OLRC_Offset[isHeavyBOSlots] −=
  NackStepSize[isHeavyBOSlots]
- Slot-level OLRC offset update
  NackStepSize[slot_idx] = 0.25 dB
  AckStepSize[slot_idx]
  = NackStepSize[slot_idx] * TargetBLER[slot_idx]/(100 −
  TargetBLER[slot_idx])
  Target BLER[slot_idx] = 10%
  if ACK; slot-level_OLRC_Offset[slot_idx] += AckStepSize[slot_idx]
  if NACK; slot-level_OLRC_Offset[slot_idx] −=
  NackStepSize[slot_idx]
```

With reference to Equation 19, the base station may determine the MCS of each slot unit based on Equation 20 below.

$$SINRwithOLRC ( for MCS selection ) = SINR ( from CQI ) + main\_OLRC \_Offset + slotlevel\_OLRC \_Offset [ slot\_idx ] + grouplevel\_OLRC \_Offset [ isHeavyBOslots ] \qquad [ Equation 20 ]$$

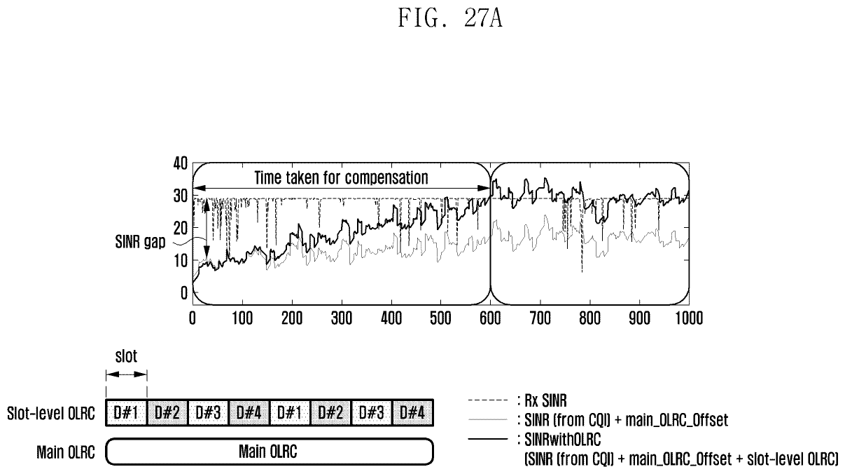

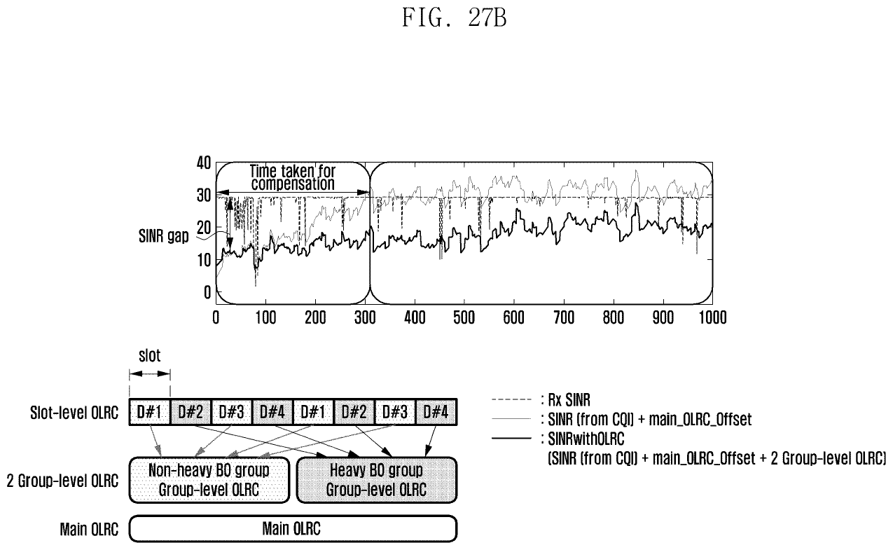

FIGS. 27A and 27B are diagrams illustrating graphs comparing the times for a base station to adapt to a channel state for each case where slot groups are formed in multiple layers or in a single layer.

In FIGS. 27A and 27B, the channel states for D #1, D #2, D #3, and D #4 may be different from each other, as in the example shown in FIG. 25. For example, the SINR values for D #1, D #2, D #3, and D #4 may be different from each other. The graphs of FIGS. 27A and 27B can show a process in which the base station adapts to the channel state for slot D #4. For example, the graphs of FIGS. 27A and 27B can show a process in which the base station predicts the SINR of a channel for slot D #4. In FIGS. 27A and 27B, the actual SINR of a receiver (Rx) and/or the SINR value predicted by the base station correspond to the SINR value of the channel for D #4, and accordingly, the SINR values shown in FIGS. 27A and 27B may be different from the SINR values of the respective channels for D #1, D #2, and D #3.

FIG. 27A illustrates a diagram of graphs comparing the times for the base station to adapt to the channel state for the case where slot groups are formed in a single layer and the case where slot groups are formed in two layers according to an embodiment of the present disclosure. Specifically, FIG. 27A shows graphs comparing the times for the base station to adapt to the channel state for the case where slot groups are formed in a single layer such that all slots D #1 to D #4 belong to the same slot group and the case where slot groups are formed in two layers such that in the first layer, D #1 to D #4 belong to the first group, and in the second layer, D #1 to D #4 belong to the first group to the fourth group, respectively.

In FIG. 27A, the horizontal axis represents the time domain, and the vertical axis represents the SINR. In FIG. 27A, the thin dotted line denotes the actual SINR of the receiver (Rx). The thin solid line denotes the process of the base station adapting to the channel state when slot groups are formed in a single layer. The thick solid line denotes the process of the base station adapting to the channel state when slot groups are formed in two layers.

With reference to FIG. 27A, when slot groups are formed in a single layer, the base station may adjust the SINR value by summing up the SINR value inferred from the CQI received from the UE and the main_OLRC_Offset based on HARQ ACK/NACK feedback in order to compensate for the SINR gap, which represents the difference between the actual SINR of the Rx and the predicted SINR. In contrast, when slot groups are formed in two layers, the base station may adjust the SINR value by summing up the SINR value inferred from the CQI received from the UE, the main_OLRC_Offset of the first layer based on HARQ ACK/NACK feedback, and the slot-level OLRC of the second layer in order to compensate for the SINR gap. Meanwhile, when calculating the main_OLRC_Offset and the slot-level OLRC, the base station may set differently AckStepSize and/or NackStepSize values for each group. By doing so, the base station can predict a more appropriate SINR value for the channel state.

According to FIG. 27A, when slot groups are formed in a single layer, the base station may fail to compensate for the SINR gap. In other words, when slot groups are formed in a single layer, the base station may fail to perform accurate SINR prediction for each slot. On the other hand, when slot groups are formed in two layers, the base station may take a time about 600 ms to compensate for the SINR gap, which represents the difference between the actual SINR of Rx and the predicted SINR. In other words, when slot groups are formed in two layers, the base station may take a time about 600 ms to perform accurate SINR prediction for each slot.

FIG. 27B illustrates a diagram of graphs comparing the times for the base station to adapt to the channel state for the case where slot groups are formed in a single layer and the case where slot groups are formed in three layers according to an embodiment of the present disclosure. Specifically, FIG. 27B shows graphs comparing the times for the base station to adapt to the channel state for the case where slot groups are formed in a single layer such that all slots D #1 to D #4 belong to the same slot group and the case where slot groups are formed in three layers such that in the first layer, D #1 to D #4 belong to the first group, in the second layer, D #1 and D #3 belong to the first group (non-Heavy BO group) and D #2 and D #4 belong to the second group (Heavy BO group), and in the third layer, D #1 to D #4 belong to the first group to the fourth group, respectively.

In FIG. 27B, the horizontal axis represents the time domain, and the vertical axis represents the SINR. In FIG. 27B, the thin dotted line denotes the actual SINR of the receiver (Rx). The thin solid line denotes the process in which the base station adapts to the channel state when slot groups are formed in a single layer. The thick solid line denotes the process in which the base station adapts to the channel state when slot groups are formed in three layers.

With reference to FIG. 27B, when slot groups are formed in a single layer, the base station may adjust the SINR value by summing up the SINR value inferred from the CQI received from the UE and the main_OLRC_Offset based on HARQ ACK/NACK feedback in order to compensate for the SINR gap, which represents the difference between the actual SINR of the Rx and the predicted SINR. In contrast, when slot groups are formed in three layers, the base station may adjust the SINR value by summing up the SINR value inferred from the CQI received from the UE, the main_OLRC_Offset of the first layer based on HARQ ACK/NACK feedback, the 2 Group-level OLRC of the second layer, and the slot-level OLRC of the third layer in order to compensate for the SINR gap. Meanwhile, when calculating the main_OLRC_Offset, the 2 Group-level OLRC, and the slot-level OLRC, the base station may set differently AckStepSize and/or NackStepSize values for each group. By doing so, the base station may predict a more appropriate SINR value for the channel state.

According to FIG. 27B, when slot groups are formed in a single layer, the base station may fail to compensate for the SINR gap. In other words, when slot groups are formed in a single layer, the base station may fail to perform accurate SINR prediction for each slot. On the other hand, when slot groups are formed in three layers, the base station may take a time about 300 ms to compensate for the SINR gap, which represents the difference between the actual SINR of Rx and the predicted SINR. In other words, when slot groups are formed in three layers, the base station may take a time about 300 ms to perform accurate SINR prediction for each slot.

As a result, the base station according to the disclosure can make a precise MCS determination suitable for the channel state of an individual slot by generating slot groups of multiple layers even when a plurality of interference control techniques are applied, and also can perform the MCS determination more efficiently for a rapidly changing channel state.

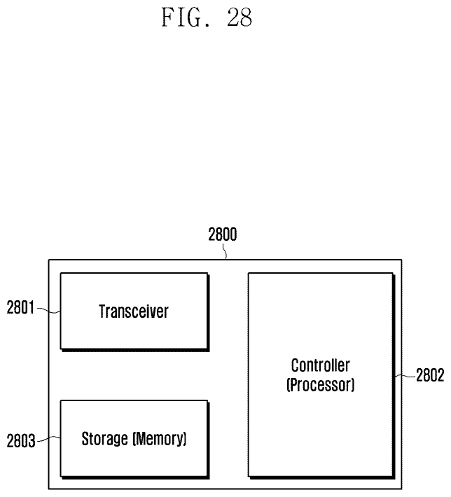

FIG. 28 illustrates a block diagram of a UE in a wireless communication system according to an embodiment of the present disclosure.

With reference to FIG. 28, the UE 2800 may include a transceiver 2801, a controller (or processor) 2802, and a storage (or memory) 2803. In the UE 2800, the transceiver 2801, the controller 2802, and the storage 2803 may operate according to an embodiment of the disclosure. However, the components of the UE 2800 according to an embodiment are not limited to those mentioned above. According to another embodiment, the UE 2800 may include more or fewer components than the above-mentioned components. In a certain case, the transceiver 2801, the controller 2802, and the storage 2803 may be implemented in the form of a single chip.

The transceiver 2801 may be composed of a transmitter and a receiver according to another embodiment. The transceiver 2801 may transmit and receive signals to and from a base station. The signals may include control information and data. To this end, the transceiver 2801 may be composed of a radio frequency (RF) transmitter that up-converts and amplifies the frequency of an outgoing signal, an RF receiver that low-noise amplifies an incoming signal and down-converts its frequency, and the like. In addition, the transceiver 2801 may receive a signal through a radio channel and output the signal to the controller 2802, or receive a signal outputted from the controller 2802 and transmit the signal through the radio channel.

The controller 2802 may control a series of processes by which the UE 2800 can operate according to the above-described embodiment of the disclosure. To this end, the controller 2802 may include at least one processor. For example, the controller 2802 may include a communication processor (CP) that performs control for communication, and an application processor (AP) that controls higher layers such as an application program.

The storage 2803 may store control information or data included in a signal obtained by the UE 2800. The storage 2803 may have an area for storing data used for control of the controller 2802 and data generated during control of the controller 2802.

In addition, the UE 2800 may include an artificial intelligence (AI) device (not shown) capable of performing at least a part of AI processing. The AI device may include an AI processor, a memory, and/or a communication unit.

For example, the controller 2802 may operate as the AI processor or perform at least a part of the functions of the AI processor. The AI processor may learn a neural network using a program stored in the memory. Here, the neural network may be designed to simulate the structure of a human brain on a computer, and may include a plurality of network nodes having weights that simulate neurons of a human neural network. The plurality of network nodes may each transmit and receive data according to a connection relationship so as to simulate synaptic activity of neurons that neurons transmit and receive signals through synapses. Here, the neural network may include a deep learning model developed from a neural network model. In the deep learning model, the plurality of network nodes may be located in different layers and transmit and receive data according to a convolution connection relationship.

Meanwhile, the AI processor may include a data learning unit that learns a neural network for data classification/recognition. The data learning unit may classify data to be used for learning and obtain data to be learned. The data learning unit may learn a deep learning model by applying the obtained learning data to the deep learning model. For example, the deep learning model may be learned through supervised learning or unsupervised learning. In addition, the data learning unit may learn a deep learning model through reinforcement learning using feedback on whether the result of the situation judgment according to learning is correct. Learning of the deep learning model may be performed based on the data of input and output layers.

The data learning unit may be manufactured in the form of at least one hardware chip and equipped in the AI device. For example, the data learning unit may be manufactured in the form of a dedicated hardware chip for AI, or may be manufactured as a part of a general-purpose processor (e.g., central processing unit (CPU)) or a graphic-dedicated processor (e.g., graphic processor unit (GPU)) and equipped in the AI device. In addition, the data learning unit may be implemented as a software module. When implemented as a software module (or a program module including instructions), the software module may be stored in a non-transitory computer readable medium that can be read by a computer. In this case, at least one software module may be provided by an operating system (OS) or by an application.

For example, the storage 2803 may include the memory of the AI device. The memory may store various programs and data used for the operation of the AI device. The memory is accessed by the AI processor, and data may be read/recorded/modified/deleted/updated by the AI processor. For example, the data learning unit may store a learned model associated with the input/output relationship information of the PA in the memory.

For example, the communication unit of the AI device may be included in the transceiver 2803.

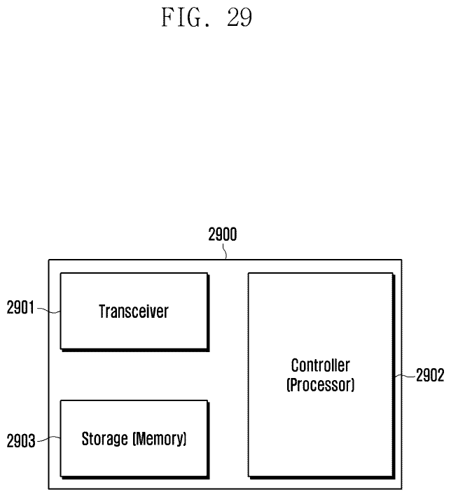

FIG. 29 illustrates a block diagram of a base station in a wireless communication system according to an embodiment of the present disclosure.

With reference to FIG. 29, the base station 2900 may include a transceiver 2901, a controller (or processor) 2902, and a storage (or memory) 2903. In the base station 2900, the transceiver 2901, the controller 2902, and the storage 2903 may operate according to an embodiment of the disclosure. However, the components of the base station 2900 according to an embodiment are not limited to those mentioned above. According to another embodiment, the base station 2900 may include more or fewer components than the above-mentioned components. In a certain case, the transceiver 2901, the controller 2902, and the storage 2903 may be implemented in the form of a single chip.

The transceiver 2901 may be composed of a transmitter and a receiver according to another embodiment. The transceiver 2901 may transmit and receive signals to and from a UE. The signals may include control information and data. To this end, the transceiver 2901 may be composed of an RF transmitter that up-converts and amplifies the frequency of an outgoing signal, an RF receiver that low-noise amplifies an incoming signal and down-converts its frequency, and the like. In addition, the transceiver 2901 may receive a signal through a radio channel and output the signal to the controller 2902, or receive a signal outputted from the controller 2902 and transmit the signal through the radio channel.

The controller 2902 may control a series of processes by which the base station 2900 can operate according to the above-described embodiment of the disclosure. To this end, the controller 2902 may include at least one processor. For example, the controller 2902 may include a CP that performs control for communication, and an AP that controls higher layers such as an application program.

The storage 2903 may store control information or data included in a signal obtained by the base station 2900. The storage 2903 may have an area for storing data used for control of the controller 2902 and data generated during control of the controller 2902.

In addition, the base station 2900 may include an AI device (not shown) capable of performing at least a part of AI processing. The AI device may include an AI processor, a memory, and/or a communication unit.

For example, the controller 2902 may operate as the AI processor or perform at least a part of the functions of the AI processor. The AI processor may learn a neural network using a program stored in the memory. Here, the neural network may be designed to simulate the structure of a human brain on a computer, and may include a plurality of network nodes having weights that simulate neurons of a human neural network. The plurality of network nodes may each transmit and receive data according to a connection relationship so as to simulate synaptic activity of neurons that neurons transmit and receive signals through synapses. Here, the neural network may include a deep learning model developed from a neural network model. In the deep learning model, the plurality of network nodes may be located in different layers and transmit and receive data according to a convolution connection relationship.

Meanwhile, the AI processor may include a data learning unit that learns a neural network for data classification/recognition. The data learning unit may classify data to be used for learning and obtain data to be learned. The data learning unit may learn a deep learning model by applying the obtained learning data to the deep learning model. For example, the deep learning model may be learned through supervised learning or unsupervised learning. In addition, the data learning unit may learn a deep learning model through reinforcement learning using feedback on whether the result of the situation judgment according to learning is correct. For example, the data learning unit may classify a received pilot portion as data of an input layer, and reflect a size scaling factor to the pilot known in advance to classify it as data of an output layer. Learning of the deep learning model may be performed based on the data of the input and output layers. In addition, inference can be performed based on the learned model by using the data portion of the received signal as the input layer.

The data learning unit may be manufactured in the form of at least one hardware chip and equipped in the AI device. For example, the data learning unit may be manufactured in the form of a dedicated hardware chip for AI, or may be manufactured as a part of a general-purpose processor (e.g., CPU) or a graphic-dedicated processor (e.g., GPU) and equipped in the AI device. In addition, the data learning unit may be implemented as a software module. When implemented as a software module (or a program module including instructions), the software module may be stored in a non-transitory computer readable medium that can be read by a computer. In this case, at least one software module may be provided by an operating system (OS) or by an application.

For example, the storage 2903 may include the memory of the AI device. The memory may store various programs and data used for the operation of the AI device. The memory is accessed by the AI processor, and data may be read/recorded/modified/deleted/updated by the AI processor. For example, the data learning unit may store a learned model associated with the input/output relationship information of the PA in the memory.

For example, the communication unit of the AI device may be included in the transceiver 2901.

The methods proposed in the disclosure may be implemented by combining part or all of the contents included in respective embodiments within the scope that does not harm the subject matter of the disclosure.

The embodiments disclosed herein may only be specific examples presented to easily explain the technical contents of the disclosure and help in understanding the disclosure, and are not intended to limit the scope of the disclosure. In other words, it is apparent to a person having ordinary skill in the technical field to which the disclosure belongs that other modified examples based on the subject matter of the disclosure are possible.

While the disclosure has been particularly shown and described with reference to an exemplary embodiment thereof, it will be understood by those skilled in the art that various changes in form and details may be made therein without departing from the scope of the disclosure as defined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a reference signal to be used for measuring channel information for each of at least one slot, including a demodulation reference signal (DMRS) related to reception of a physical downlink shared channel (PDSCH);
measuring channel information including an interference amount for each of the at least one slot, based on the reference signal;
obtaining slot-related channel information, based on the measured channel information for each of the at least one slot; and
transmitting the obtained slot-related channel information to the base station,
wherein the slot-related channel information is used to determine a modulation and coding scheme (MCS) level for each of at least one slot group.

2. The method of claim 1, wherein the slot-related channel information is channel information according to a value determined based on a modulo operation of a slot index for each of the at least one slot,
wherein the slot-related channel information includes at least one of an average interference of a plurality of slots having the same value, an average relative interference difference, a variance interference, an interference standard deviation, an average SINR estimated based on the DMRS, an average relative SINR difference estimated based on the DMRS, a variance of SINR values estimated based on the DMRS, or a standard deviation of SINR values estimated based on the DMRS,
wherein the slot-related channel information is updated in response to reception of downlink data,
wherein the slot-related channel information is transmitted based on uplink control information (UCI), and
wherein the UCI includes a field indicating a slot index value and a field indicating channel information of a slot index corresponding to the slot index value.

3. The method of claim 1, wherein transmitting the obtained slot-related channel information includes:
receiving, from the base station, a message requesting to report the slot-related channel information; and
transmitting the slot-related channel information, based on the message, and
wherein the slot-related channel information is transmitted periodically or aperiodically to the base station,
wherein aperiodically transmitting the slot-related channel information includes transmitting once or, after transmitting once, additionally transmitting when information of the message changes over a threshold value,
wherein the message is transmitted based on downlink control information (DCI),
wherein the DCI includes a field indicating a slot index value of a slot to be reported, or a field indicating channel information to be reported in a slot corresponding to the slot index value,
wherein with respect to slot configuration, in case that four consecutive slots out of five consecutive slots are configured to include only downlink (DL) symbols and a remaining one slot is configured to include only uplink (UL) symbols, the slot index value to be reported includes at least one of 1, 2, 3, or 4, and
wherein the channel information to be reported in the slot corresponding to the slot index value includes at least one of an average interference amount, an interference amount variance, or an interference amount standard deviation.

4. The method of claim 1, wherein in case that there is no restriction on slot group information that can be generated, unrestricted slot group information is predefined or transmitted to the terminal via a radio resource control (RRC),
wherein in case that there is a restriction on the slot group information that can be generated, restricted slot group information is transmitted to the terminal via the RRC,
wherein the slot-related channel information is transmitted periodically or aperiodically to the base station, and
wherein aperiodically transmitting the slot-related channel information includes transmitting once or, after transmitting once, additionally transmitting when the slot-related channel information changes over a threshold value.

5. The method of claim 1, wherein the at least one slot group is independently formed for each of at least one layer,
wherein each of the at least one slot belongs to at least one slot group formed within each of the at least one layer,
wherein the MCS level for each of the at least one slot is determined based on an offset parameter determined for each of the at least one slot group,
wherein in case that the at least one slot group includes a first group including all downlink slots of one period in a first layer, a second group including at least one slot from among all the downlink slots of one period in a second layer, and a third group including slots other than the at least one slot from among all the downlink slots of one period in the second layer, the MCS level for each of the at least one slot is determined based on a weighted sum of an offset parameter for the first group and an offset parameter for the second group or the third group, and
wherein in case that the at least one slot group includes the first group, the second group, the third group, and at least one group corresponding to each of all the downlink slots of one period in a third layer, the MCS level for each of the at least one slot is determined based on a weighted sum of the offset parameter for the first group, the offset parameter for the second group or the third group, and an offset parameter for the at least one group.

6. A method of a base station in a wireless communication system, the method comprising:
transmitting, to a terminal, a reference signal to be used for measuring channel information for each of at least one slot, including a demodulation reference signal (DMRS) related to reception of a physical downlink shared channel (PDSCH); and
receiving slot-related channel information from the terminal,
wherein the slot-related channel information is used to determine a modulation and coding scheme (MCS) level for each of at least one slot group,
wherein the slot-related channel information is information obtained by the terminal, based on channel information for each of the at least one slot measured by the terminal, and
wherein the slot-related channel information is information received from the terminal.

7. The method of claim 6, wherein the slot-related channel information is channel information according to a value determined based on a modulo operation of a slot index for each of the at least one slot,
wherein the slot-related channel information includes at least one of an average interference of a plurality of slots having the same value, an average relative interference difference, a variance interference, an interference standard deviation, an average SINR estimated based on the DMRS, an average relative SINR difference estimated based on the DMRS, a variance of SINR values estimated based on the DMRS, or a standard deviation of SINR values estimated based on the DMRS,
wherein the slot-related channel information is updated in response to reception of downlink data,
wherein the slot-related channel information is transmitted based on uplink control information (UCI), and
wherein the UCI includes a field indicating a slot index value and a field indicating channel information of a slot index corresponding to the slot index value.

8. The method of claim 6, wherein receiving the slot-related channel information includes:
transmitting, to the terminal, a message requesting to report the slot-related channel information; and
receiving the slot-related channel information, based on the message, and
wherein the slot-related channel information is received periodically or aperiodically from the terminal,
wherein aperiodically receiving the slot-related channel information includes receiving once or, after receiving once, additionally receiving when information of the message changes over a threshold value,
wherein the message is transmitted based on downlink control information (DCI),
wherein the DCI includes a field indicating a slot index value of a slot to be reported, or a field indicating channel information to be reported in a slot corresponding to the slot index value,
wherein with respect to slot configuration, in case that four consecutive slots out of five consecutive slots are configured to include only downlink (DL) symbols and a remaining one slot is configured to include only uplink (UL) symbols, the slot index value to be reported includes at least one of 1, 2, 3, or 4, and
wherein the channel information to be reported in the slot corresponding to the slot index value includes at least one of an average interference amount, an interference amount variance, or an interference amount standard deviation.

9. The method of claim 6, wherein in case that there is no restriction on slot group information that can be generated, unrestricted slot group information is predefined or transmitted to the terminal via a radio resource control (RRC),
wherein in case that there is a restriction on the slot group information that can be generated, restricted slot group information is transmitted to the terminal via the RRC,
wherein the slot-related channel information is received periodically or aperiodically from the terminal, and
wherein aperiodically receiving the slot-related channel information includes receiving once or, after receiving once, additionally receiving when the slot-related channel information changes over a threshold value.

10. The method of claim 6, wherein the at least one slot group is independently formed for each of at least one layer,
wherein each slot measured by the terminal belongs to the at least one slot group formed within each of the at least one layer,
wherein the MCS level for each slot measured by the terminal is determined based on an offset parameter determined for each of the at least one slot group,
wherein in case that the at least one slot group includes a first group including all downlink slots of one period in a first layer, a second group including at least one slot from among all the downlink slots of one period in a second layer, and a third group including slots other than the at least one slot from among all the downlink slots of one period in the second layer, the MCS level for each of the at least one slot is determined based on a weighted sum of an offset parameter for the first group and an offset parameter for the second group or the third group, and
wherein in case that the at least one slot group includes the first group, the second group, the third group, and at least one group corresponding to each of all the downlink slots of one period in a third layer, the MCS level for each of the at least one slot is determined based on a weighted sum of the offset parameter for the first group, the offset parameter for the second group or the third group, and an offset parameter for the at least one group.

11. A terminal in a wireless communication system, the terminal comprising:
a transceiver; and
a processor operatively connected to the transceiver and configured to:
receive, from a base station, a reference signal to be used for measuring channel information for each of at least one slot, including a demodulation reference signal (DMRS) related to reception of a physical downlink shared channel (PDSCH),
measure channel information including an interference amount for each of the at least one slot, based on the reference signal,
obtain slot-related channel information, based on the measured channel information for each of the at least one slot, and
transmit the obtained slot-related channel information to the base station,
wherein the slot-related channel information is used to determine a modulation and coding scheme (MCS) level for each of at least one slot group.

12. The terminal of claim 11, wherein the slot-related channel information is channel information according to a value determined based on a modulo operation of a slot index for each of the at least one slot,
wherein the slot-related channel information includes at least one of an average interference of a plurality of slots having the same value, an average relative interference difference, a variance interference, an interference standard deviation, an average SINR estimated based on the DMRS, an average relative SINR difference estimated based on the DMRS, a variance of SINR values estimated based on the DMRS, or a standard deviation of SINR values estimated based on the DMRS,
wherein the slot-related channel information is updated in response to reception of downlink data,
wherein the slot-related channel information is transmitted based on uplink control information (UCI), and
wherein the UCI includes a field indicating a slot index value and a field indicating channel information of a slot index corresponding to the slot index value.

13. The terminal of claim 11, wherein the processor is configured to:
receive, from the base station, a message requesting to report the slot-related channel information, and
transmit the slot-related channel information, based on the message, and
wherein the slot-related channel information is transmitted periodically or aperiodically to the base station,
wherein aperiodically transmitting the slot-related channel information includes transmitting once or, after transmitting once, additionally transmitting when information of the message changes over a threshold value,
wherein the message is transmitted based on downlink control information (DCI),
wherein the DCI includes a field indicating a slot index value of a slot to be reported, or a field indicating channel information to be reported in a slot corresponding to the slot index value,
wherein with respect to slot configuration, in case that four consecutive slots out of five consecutive slots are configured to include only downlink (DL) symbols and a remaining one slot is configured to include only uplink (UL) symbols, the slot index value to be reported includes at least one of 1, 2, 3, or 4, and
wherein the channel information to be reported in the slot corresponding to the slot index value includes at least one of an average interference amount, an interference amount variance, or an interference amount standard deviation.

14. The terminal of claim 11, wherein in case that there is no restriction on slot group information that can be generated, unrestricted slot group information is predefined or transmitted to the terminal via a radio resource control (RRC),
wherein in case that there is a restriction on the slot group information that can be generated, restricted slot group information is transmitted to the terminal via the RRC,
wherein the slot-related channel information is transmitted periodically or aperiodically to the base station, and
wherein aperiodically transmitting the slot-related channel information includes transmitting once or, after transmitting once, additionally transmitting when the slot-related channel information changes over a threshold value.

15. The terminal of claim 11, wherein the at least one slot group is independently formed for each of at least one layer,
wherein each of the at least one slot belongs to the at least one slot group formed within each of the at least one layer,
wherein the MCS level for each of the at least one slot is determined based on an offset parameter determined for each of the at least one slot group,
wherein in case that the at least one slot group includes a first group including all downlink slots of one period in a first layer, a second group including at least one slot from among all the downlink slots of one period in a second layer, and a third group including slots other than the at least one slot from among all the downlink slots of one period in the second layer, the MCS level for each of the at least one slot is determined based on a weighted sum of an offset parameter for the first group and an offset parameter for the second group or the third group, and
wherein in case that the at least one slot group includes the first group, the second group, the third group, and at least one group corresponding to each of all the downlink slots of one period in a third layer, the MCS level for each of the at least one slot is determined based on a weighted sum of the offset parameter for the first group, the offset parameter for the second group or the third group, and an offset parameter for the at least one group.

16. A base station in a wireless communication system, the base station comprising:
a transceiver; and
a processor operatively connected to the transceiver and configured to:
transmit, to a terminal, a reference signal to be used for measuring channel information for each of at least one slot, including a demodulation reference signal (DMRS) related to reception of a physical downlink shared channel (PDSCH), and
receive slot-related channel information from the terminal,
wherein the slot-related channel information is used to determine a modulation and coding scheme (MCS) level for each of at least one slot group,
wherein the slot-related channel information is information obtained by the terminal, based on channel information for each of the at least one slot measured by the terminal, and
wherein the slot-related channel information is information received from the terminal.

17. The base station of claim 16, wherein the slot-related channel information is channel information according to a value determined based on a modulo operation of a slot index for each of the at least one slot,
wherein the slot-related channel information includes at least one of an average interference of a plurality of slots having the same value, an average relative interference difference, a variance interference, an interference standard deviation, an average SINR estimated based on the DMRS, an average relative SINR difference estimated based on the DMRS, a variance of SINR values estimated based on the DMRS, or a standard deviation of SINR values estimated based on the DMRS,
wherein the slot-related channel information is updated in response to reception of downlink data,
wherein the slot-related channel information is transmitted based on uplink control information (UCI), and
wherein the UCI includes a field indicating a slot index value and a field indicating channel information of a slot index corresponding to the slot index value.

18. The base station of claim 16, wherein the processor is configured to:
transmit, to the terminal, a message requesting to report the slot-related channel information, and
receive the slot-related channel information, based on the message, and
wherein the slot-related channel information is received periodically or aperiodically from the terminal,
wherein aperiodically receiving the slot-related channel information includes receiving once or, after the receiving once, additionally receiving when information of the message changes over a threshold value,
wherein the message is transmitted based on downlink control information (DCI),
wherein the DCI includes a field indicating a slot index value of a slot to be reported, or a field indicating channel information to be reported in a slot corresponding to the slot index value,
wherein with respect to slot configuration, in case that four consecutive slots out of five consecutive slots are configured to include only downlink (DL) symbols and remaining one slot is configured to include only uplink (UL) symbols, the slot index value to be reported includes at least one of 1, 2, 3, or 4, and
wherein the channel information to be reported in the slot corresponding to the slot index value includes at least one of an average interference amount, an interference amount variance, or an interference amount standard deviation.

19. The base station of claim 16, wherein in case that there is no restriction on slot group information that can be generated, unrestricted slot group information is predefined or transmitted to the terminal via a radio resource control (RRC),
wherein in case that there is a restriction on the slot group information that can be generated, restricted slot group information is transmitted to the terminal via the RRC,
wherein the slot-related channel information is received periodically or aperiodically from the terminal, and
wherein aperiodically receiving the slot-related channel information includes receiving once or, after the receiving once, additionally receiving when the slot-related channel information changes over a threshold value.

20. The base station of claim 16, wherein the at least one slot group is independently formed for each of at least one layer,
wherein each slot measured by the terminal belongs to the at least one slot group formed within each of the at least one layer,
wherein the MCS level for each slot measured by the terminal is determined based on an offset parameter determined for each of the at least one slot group,
wherein in case that the at least one slot group includes a first group including all downlink slots of one period in a first layer, a second group including at least one slot from among all the downlink slots of one period in a second layer, and a third group including slots other than the at least one slot from among all the downlink slots of one period in the second layer, the MCS level for each of the at least one slot is determined based on a weighted sum of an offset parameter for the first group and an offset parameter for the second group or the third group, and
wherein in case that the at least one slot group includes the first group, the second group, the third group, and at least one group corresponding to each of all the downlink slots of one period in a third layer, the MCS level for each of the at least one slot is determined based on a weighted sum of the offset parameter for the first group, the offset parameter for the second group or the third group, and an offset parameter for the at least one group.
